(19) United States
(12) Patent Application Publication
(10) Pub. No.: US 2015/0021022 A1
(43) Pub. Date: Jan. 22, 2015

(54) ENERGIZED SLURRIES AND METHODS

(71) Applicant: Schlumberger Technology Corporation, Sugar Land, TX (US)

(72) Inventors: Hemant Kumar J. Ladva, Missouri City, TX (US); Yiyan Chen, Sugar Land, TX (US); Anthony Loiseau, Sugar Land, TX (US)

(21) Appl. No.: 13/944,651

(22) Filed: Jul. 17, 2013

(51) Int. Cl. C09K 8/80; E21B 43/267

(52) U.S. Cl. CPC C09K 8/805; E21B 43/267
USPC 166/276; 507/226; 507/202

(57) ABSTRACT

Energized slurries (including foams) comprising an Apollonian particle mixture and at least one additive selected from the group consisting of viscosifiers, gelling agents and rheological agents. Also, methods, fluids, equipment and/or systems for treating a subterranean formation penetrated by a wellbore, relating to treatment fluids based on the energized slurries.

### RELATED APPLICATION DATA

None.

### BACKGROUND

The statements in this section merely provide background information related to the present disclosure and may not constitute prior art.

This application relates to slurries, and to well treatment slurries, systems, equipment, methods, based on the slurries and related embodiments.

A number of fracturing fluid formulations have been developed using high-solid fluids that present advantages over conventional fracturing fluids, including long term stability, high proppant concentration, high density, good leak-off control, etc. However, proppant pack permeability can be low, e.g., the presence of micrometric particles may reduce the ability to produce gas or oil. High-solid formulations are desired that maintain one or more of their advantages relative to conventional fluids, and that also can improve the clean-up phase and proppant pack conductivity, and thus production. Also desired are high-solid formulations that can improve stability, flowability and/or provide a better environmental foot print.

### SUMMARY

In some embodiments herein, the treatments, treatment fluids, systems, equipment, methods, and the like employ a stabilized treatment slurry (STS) which is energized, wherein the dispersed phase comprises solids, which may include proppant, and the solids are at least temporarily inhibited from gravitational settling in the continuous fluid phase. In some embodiments, the energized carrier fluid may comprise at least one additive selected from the group consisting of viscosifiers, gelling agents and rheological agents. In some embodiments, the dispersed gas forms an energized fluid or a foam that can enhance the hydraulic conductivity of a solids pack made from the energized STS. In some embodiments, the STS may have an at least temporarily controlled rheology, such as, for example, viscosity, leakoff or yield strength, or other physical property, such as, for example, specific gravity, solids volume fraction (SVF), or the like. In some embodiments, the solids phase of the STS may have an at least temporarily controlled property, such as, for example, particle size distribution (including modality(ies)), packed volume fraction (PVF), density(ies), aspect ratio(s), sphericity(ies), roundness(es) (or angularity(ies)), strength(s), permeability(ies), solubility(ies), reactivity(ies), etc.

In embodiments, an energized high solid content slurry that includes dispersed gas bubbles enables a wide array of potential benefits in the oil field sector, e.g., enhanced fracture conductivity and/or width, as well as long term stability, very high proppant concentration, high density, good leak-off control, smaller environmental footprint, or a combination thereof. In various embodiments, the energized slurry may be used to achieve conductive channels for flow of hydrocarbons, fluid loss control, etc.

In some embodiments, a fracture treatment method may comprise forming a fracture in a subterranean formation penetrated by a wellbore; introducing into the fracture a stabilized slurry comprising an Apollonian particle mixture comprising solids including at least one proppant mode dispersed in an energized carrier fluid with at least one additive selected from the group consisting of viscosifiers, gelling agents and rheological agents, to form a proppant pack in the fracture; removing gas from the proppant pack to form hydraulically conductive channels; and producing a reservoir fluid through the proppant pack into the wellbore.

### BRIEF DESCRIPTION OF THE DRAWINGS

These and other features and advantages will be better understood by reference to the following detailed description when considered in conjunction with the accompanying drawings.

FIG. 1 shows a schematic slurry state progression chart for a treatment fluid according to some embodiments of the current application.

FIG. 2 illustrates fluid stability regions for a treatment fluid according to some embodiments of the current application.

FIG. 3 shows the leakoff property of a low viscosity, stabilized treatment slurry (STS) (lower line) according to some embodiments of the current application compared to conventional crosslinked fluid (upper line).

FIG. 4 shows a schematic representation of the wellsite equipment configuration with onsite mixing of an STS according to some embodiments of the current application.

FIG. 5 shows a schematic representation of the wellsite equipment configuration with a pump-ready STS according to some embodiments of the current application.

FIG. 6 is a schematic diagram showing a fracture propped with an energized STS according to some embodiments of the current application.

FIG. 7 is a schematic diagram showing production from the fracture of FIG. 6 following gas breakthrough and the creation of highly permeable channels according to some embodiments of the current application.

FIG. 8 is a schematic diagram showing a fracture propped with another energized STS comprising bimodal proppant according to some embodiments of the current application.

FIG. 9 is a schematic diagram showing the fracture of FIG. 8 following gas removal according to some embodiments of the current application.

FIG. 10 is a schematic diagram showing a fracture propped with another energized STS comprising oil emulsion droplets according to some embodiments of the current application.

FIG. 11 is a schematic diagram showing the fracture of FIG. 10 following gas and oil droplet removal according to some embodiments of the current application.

FIG. 12 is a schematic diagram showing an energized STS according to some embodiments of the current application.

FIG. 13 is a schematic diagram showing the slurry of FIG. 12 following foam removal according to some embodiments of the current application.

FIG. 14 is a graph of the fluid loss of a non-foamed slurry compared to a 35% foam quality STS as in Example 11 according to some embodiments of the current application.

FIG. 15 is a schematic diagram showing a side by side comparison of the sedimentation of non-foamed slurry (left) and foamed STS (right) after 24 hours settling time according to some embodiments of the current application.

FIG. 16 is a schematic diagram showing a side by side comparison of the sedimentation of the non-foamed slurry (left) and foamed STS (right) of FIG. 15 after 48 hours settling time according to some embodiments of the current application.

FIG. 17 is a schematic diagram showing a side by side comparison of the sedimentation of the non-foamed slurry (left) and foamed STS (right) of FIG. 15 after 96 hours settling time according to some embodiments of the current application.

### DETAILED DESCRIPTION OF SOME ILLUSTRATIVE EMBODIMENTS

For the purposes of promoting an understanding of the principles of the disclosure, reference will now be made to some illustrative embodiments of the current application. Like reference numerals used herein refer to like parts in the various drawings. Reference numerals without suffixed letters refer to the part(s) in general; reference numerals with suffixed letters refer to a specific one of the parts.

As used herein, “embodiments” refers to non-limiting examples of the application disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Moreover, the schematic illustrations and descriptions provided herein are understood to be examples only, and components and operations may be combined or divided, and added or removed, as well as re-ordered in whole or part, unless stated explicitly to the contrary herein. Certain operations illustrated may be implemented by a computer executing a computer program product on a computer readable medium, where the computer program product comprises instructions causing the computer to execute one or more of the operations, or to issue commands to other devices to execute one or more of the operations.

In embodiments, a well treatment fluid comprises a stabilized, flowable slurry comprising an Apollonian solids mixture comprising solids dispersed in an energized carrier fluid with at least one additive selected from the group consisting of viscosifiers, gelling agents and rheological agents. In some embodiments, the treatment fluid may comprise a dispersed particle volume fraction (DPVF) of at least 40%, wherein the dispersed particles comprise solids, foam and optionally dispersed immiscible liquid particles, and wherein the DPVF is defined as the sum of the packed volume fraction (PVF) of the solids plus the foam quality plus the volume of any optional dispersed liquid particles. In some embodiments, DPVF may be at least 50%, at least 60%, at least 70%, at least 80%, at least 90%, or at least 95%. In some embodiments, the carrier fluid further comprises a dispersed liquid phase immiscible in a continuous liquid phase.

In some embodiments, the solids comprise proppant. In some embodiments, the solids comprise at least two particle size modes comprising at least one proppant mode. In some embodiments, the particle mixture comprises subproppant foam particles. In some embodiments, two proppant modes. In some embodiments, the solids mixture comprises a first proppant mode having a particle size greater than 100 microns and a second proppant mode having a particle size smaller than the first proppant mode.

In some embodiments, the carrier fluid is energized with carbon dioxide. In some embodiments, the carrier fluid is energized with air. In some embodiments, the carrier fluid is energized with nitrogen. Said carrier fluid may also be energized with helium, argon, or hydrocarbon gases (such as methane, ethane, propane, butane, pentane, hexane, heptane . . . ), and mixtures thereof.

In some embodiments, the treatment fluid may comprise at least one of the stability indicia selected from: (1) a dispersed particle volume fraction (DPVF) of at least 0.4, preferably at least 0.5 or at least 0.6; (2) a low-shear viscosity of at least 1 Pa-s (5.11 s⁻¹, 25° C.); (3) a yield stress of at least 1 Pa; (4) an apparent viscosity of at least 50 mPa-s (170 s⁻¹, 25° C.); (5) a multimodal solids phase; (6) a solids phase having a packed volume fraction (PVF) greater than 0.7; (7) a viscosifier selected from viscoelastic surfactants, in an amount ranging from 0.01 up to 7.2 g/L (60 ppt), and hydratable gelling agents in an amount ranging from 0.01 up to 4.8 g/L (40 ppt) based, on the volume of fluid phase; (8) colloidal particles; (9) a solid particle-fluid density delta less than 1.6 g/mL; (10) particles having an aspect ratio of at least 6; (11) ciliated or coated proppant; and (12) combinations thereof.

In some embodiments, a fracture treatment method may comprise forming a fracture in a subterranean formation penetrated by a wellbore; introducing the treatment fluid into the fracture to form a proppant pack in the fracture; removing gas from the proppant pack to form hydraulically conductive channels; and producing a reservoir fluid through the proppant pack into the wellbore.

In some embodiments, the method may comprise dispersing into the slurry a liquid phase immiscible in a continuous liquid phase.

In some embodiments, the energized carrier fluid comprises a foam quality effective to facilitate fluid loss control in the fracture.

In some embodiments, the energized carrier fluid comprises a foam quality effective to increase viscosity of the stabilized slurry and facilitate formation of a relatively wider fracture.

In some embodiments, the method may further comprise expanding gas in the carrier fluid to drive flowback through the proppant pack to the wellbore.

In some embodiments, the energized carrier fluid comprises a foam quality effective to promote slot flow of the solids in the fracture.

In some embodiments, the method may comprise energizing the carrier fluid with carbon dioxide. In some embodiments, the method may comprise energizing the carrier fluid with air, helium, argon, nitrogen, or hydrocarbon gases (such as methane, ethane, propane, butane, pentane, hexane, heptane . . . ), and mixtures thereof. In some embodiments, the method may comprise energizing the carrier fluid downhole with a foam-generating agent.

In some embodiments, the carrier fluid comprises surfactant to change wettability of a surface of the formation.

In some embodiments, the stabilized slurry may be formed by at least one of: (1) introducing sufficient particles into the slurry to increase the dispersed particle volume fraction (DPVF) of the slurry to at least 0.4, preferably at least 0.5 or at least 0.6; (2) increasing a low-shear viscosity of the slurry to at least 1 Pa-s (5.11 s⁻¹, 25° C.); (3) increasing a yield stress of the slurry to at least 1 Pa; (4) increasing apparent viscosity of the slurry to at least 50 mPa-s (170 s⁻¹, 25° C.); (5) introducing a multimodal solids phase into the slurry; (6) introducing a solids phase having a packed volume fraction (PVF) greater than 0.7 into the slurry; (7) introducing into the slurry a viscosifier selected from viscoelastic surfactants and hydratable gelling agents; (8) introducing colloidal particles into the slurry; (9) reducing a particle-fluid density delta in the slurry to less than 1.6 g/mL; (10) introducing particles into the slurry having an aspect ratio of at least 6; (11) introducing ciliated or coated proppant into the slurry; and (12) combinations thereof.

It should be understood that, although a substantial portion of the following detailed description may be provided in the context of oilfield hydraulic fracturing operations, other oilfield operations such as cementing, gravel packing, etc., or even non-oilfield well treatment operations, can utilize and benefit as well from the disclosure of the present treatment slurry.

As used herein, the terms “treatment fluid” or “wellbore treatment fluid” are inclusive of “fracturing fluid” or “treatment slurry” and should be understood broadly. These may be or include a liquid, a solid, a gas, and combinations thereof, as will be appreciated by those skilled in the art. A treatment fluid may take the form of a solution, an emulsion, slurry, or any other form as will be appreciated by those skilled in the art.

As used herein, “slurry” refers to an optionally flowable mixture of particles dispersed in a fluid carrier. The terms “flowable” or “pumpable” or “mixable” are used interchangeably herein and refer to a fluid or slurry that has either a yield stress or low-shear (5.11 s⁻¹) viscosity less than 1000 Pa and a dynamic apparent viscosity of less than 10 Pa-s (10,000 cP) at a shear rate 170 s⁻¹, where yield stress, low-shear viscosity and dynamic apparent viscosity are measured at a temperature of 25° C. unless another temperature is specified explicitly or in context of use.

“Viscosity” as used herein unless otherwise indicated refers to the apparent dynamic viscosity of a fluid at a temperature of 25° C. and shear rate of 170 s⁻¹. “Low-shear viscosity” as used herein unless otherwise indicated refers to the apparent dynamic viscosity of a fluid at a temperature of 25° C. and shear rate of 5.11 s⁻¹. Yield stress and viscosity of the treatment fluid are evaluated at 25° C. in a Fann 35 rheometer with an R1B5F1 spindle, or an equivalent rheometer/spindle arrangement, with shear rate ramped up to 255 s⁻¹ (300 rpm) and back down to 0, an average of the two readings at 2.55, 5.11, 85.0, 170 and 255 s⁻¹ (3, 6, 100, 200 and 300 rpm) recorded as the respective shear stress, the apparent dynamic viscosity is determined as the ratio of shear stress to shear rate (τ/γ) at γ=170 s⁻¹, and the yield stress (τ₀) (if any) is determined as the y-intercept using a best fit of the Herschel-Buckley rheological model, τ=τ₀+k(y)ⁿ, where T is the shear stress, k is a constant, γ is the shear rate and n is the power law exponent. Where the power law exponent is equal to 1, the Herschel-Buckley fluid is known as a Bingham plastic. Yield stress as used herein is synonymous with yield point and refers to the stress required to initiate flow in a Bingham plastic or Herschel-Buckley fluid system calculated as the y-intercept in the manner described herein. A “yield stress fluid” refers to a Herschel-Buckley fluid system, including Bingham plastics or another fluid system in which an applied non-zero stress as calculated in the manner described herein is required to initiate fluid flow.

For purposes of this disclosure, the terms “energized fluid” and “foam” refer to a fluid which when subjected to a low pressure environment liberates or releases gas from solution or dispersion, for example, a liquid containing dissolved gases. Foam or energized fluids are stable mixture of gases and liquids that form a two-phase system. Foam and energized fracturing fluids are generally described by their foam quality, i.e. the ratio of gas volume to the foam volume (fluid phase of the treatment fluid), i.e., the ratio of the gas volume to the sum of the gas plus liquid volumes). If the foam quality is between 52% and 95%, the energized fluid is usually called foam. Above 95%, foam is generally changed to mist. In the present patent application, the term “energized fluid” also encompasses foams and refers to any stable mixture of gas and liquid, regardless of the foam quality. Energized fluids comprise any of:
(a) Liquids that at bottom hole conditions of pressure and temperature are close to saturation with a species of gas. For example the liquid can be aqueous and the gas nitrogen or carbon dioxide. Associated with the liquid and gas species and temperature is a pressure called the bubble point, at which the liquid is fully saturated. At pressures below the bubble point, gas emerges from solution;
(b) Foams, consisting generally of a gas phase, an aqueous phase and a solid phase. At high pressures the foam quality is typically low (i.e., the non-saturated gas volume is low), but quality (and volume) rises as the pressure falls. Additionally, the aqueous phase may have originated as a solid material and once the gas phase is dissolved into the solid phase, the viscosity of solid material is decreased such that the solid material becomes a liquid; or
(c) Liquefied gases.

The following conventions with respect to slurry terms are intended herein unless otherwise indicated explicitly or implicitly by context.

“Treatment fluid” or “fluid” (in context) refers to the entire treatment fluid, including any proppant, subproppant particles, liquid, gas etc. “Whole fluid,” “total fluid” and “base fluid” are used herein to refer to the fluid phase plus any subproppant particles dispersed therein, but exclusive of proppant particles. “Carrier,” “fluid phase” or “liquid phase” refer to the fluid or liquid that is present, which may comprise a continuous phase and optionally one or more discontinuous fluid phases dispersed in the continuous phase, including any solutes, thickeners or colloidal particles only, exclusive of other solid phase particles; reference to “water” in the slurry refers only to water and excludes any particles, solutes, thickeners, colloidal particles, etc.; reference to “aqueous phase” refers to a carrier phase comprised predominantly of water, which may be a continuous or dispersed phase. As used herein the terms “liquid” or “liquid phase” encompasses both liquids per se and supercritical fluids, including any solutes dissolved therein.

The measurement or determination of the viscosity of the liquid phase (as opposed to the treatment fluid or base fluid) may be based on a direct measurement of the solids-free liquid, or a calculation or correlation based on a measurement(s) of the characteristics or properties of the liquid containing the solids, or a measurement of the solids-containing liquid using a technique where the determination of viscosity is not affected by the presence of the solids. As used herein, solids-free for the purposes of determining the viscosity of the liquid phase means in the absence of non-colloidal particles larger than 1 micron such that the particles do not affect the viscosity determination, but in the presence of any submicron or colloidal particles that may be present to thicken and/or form a gel with the liquid, i.e., in the presence of ultrafine particles that can function as a thickening agent. In some embodiments, a “low viscosity liquid phase” means a viscosity less than about 300 mPa-s measured without any solids greater than 1 micron at 170 s⁻¹ and 25° C.

In some embodiments, the treatment fluid may include a continuous fluid phase, also referred to as an external phase, and a discontinuous phase(s), also referred to as an internal phase(s), which may be a fluid (liquid or gas) in the case of an emulsion, foam or energized fluid, or which may be a solid in the case of a slurry. The continuous fluid phase may be any matter that is substantially continuous under a given condition. Examples of the continuous fluid phase include, but are not limited to, water, hydrocarbon, gas, liquefied gas, etc., which may include solutes, e.g. the fluid phase may be a brine, and/or may include a brine or other solution(s). In some embodiments, the fluid phase(s) may optionally include a viscosifying and/or yield point agent and/or a portion of the total amount of viscosifying and/or yield point agent present. Some non-limiting examples of the fluid phase(s) include hydratable gels (e.g. gels containing polysaccharides such as guars, xanthan and diutan, hydroxyethylcellulose, polyvinyl alcohol, other hydratable polymers, colloids, etc.), a cross-linked hydratable gel, a viscosified acid (e.g. gel-based), an emulsified acid (e.g. oil outer phase), an energized fluid (e.g., an N₂ or CO₂ based foam), a viscoelastic surfactant (VES) viscosified fluid, and an oil-based fluid including a gelled, foamed, or otherwise viscosified oil.

The discontinuous phase if present in the treatment fluid may be any particles (including fluid droplets) that are suspended or otherwise dispersed in the continuous phase in a disjointed manner. In this respect, the discontinuous phase can also be referred to, collectively, as “particle” or “particulate” which may be used interchangeably. As used herein, the term “particle” should be construed broadly. For example, in some embodiments, the particle(s) of the current application are solid such as proppant, sands, ceramics, crystals, salts, etc.; however, in some other embodiments, the particle(s) can be liquid, gas, foam, emulsified droplets, etc. Moreover, in some embodiments, the particle(s) of the current application are substantially stable and do not change shape or form over an extended period of time, temperature, or pressure; in some other embodiments, the particle(s) of the current application are degradable, dissolvable, deformable, meltable, sublimeable, or otherwise capable of being changed in shape, state, or structure.

In certain embodiments, the particle(s) is substantially round and spherical. In some certain embodiments, the particle(s) is not substantially spherical and/or round, e.g., it can have varying degrees of sphericity and roundness, according to the API RP-60 sphericity and roundness index. For example, the particle(s) may have an aspect ratio, defined as the ratio of the longest dimension of the particle to the shortest dimension of the particle, of more than 2, 3, 4, 5 or 6. Examples of such non-spherical particles include, but are not limited to, fibers, flakes, discs, rods, stars, etc. All such variations should be considered within the scope of the current application.

The particles in the slurry in various embodiments may be multimodal. As used herein multimodal refers to a plurality of particle sizes or modes which each has a distinct size or particle size distribution, e.g., proppant and fines. As used herein, the terms distinct particle sizes, distinct particle size distribution, or multi-modes or multimodal, mean that each of the plurality of particles has a unique volume-averaged particle size distribution (PSD) mode. That is, statistically, the particle size distributions of different particles appear as distinct peaks (or “modes”) in a continuous probability distribution function. For example, a mixture of two particles having normal distribution of particle sizes with similar variability is considered a bimodal particle mixture if their respective means differ by more than the sum of their respective standard deviations, and/or if their respective means differ by a statistically significant amount. In certain embodiments, the particles contain a bimodal mixture of two particles; in certain other embodiments, the particles contain a trimodal mixture of three particles; in certain additional embodiments, the particles contain a tetramodal mixture of four particles; in certain further embodiments, the particles contain a pentamodal mixture of five particles, and so on. Representative references disclosing multimodal particle mixtures include U.S. Pat. No. 5,518,996, U.S. Pat. No. 7,784,541, U.S. Pat. No. 7,789,146, U.S. Pat. No. 8,008,234, U.S. Pat. No. 8,119,574, U.S. Pat. No. 8,210,249, US 2010/0300688, US 2012/0000641, US 2012/0138296, US 2012/0132421, US 2012/0111563, WO 2012/054456, US 2012/0305245, US 2012/0305254, US 2012/0132421, PCT/RU2011/000971 and U.S. Ser. No. 13/415,025, each of which are hereby incorporated herein by reference.

As used herein, an Apollonian particle mixture is a multimodal particle mixture comprising at least three modes wherein each successively smaller mode has a particle size from one-half to one-tenth the particle size of the immediately larger mode and wherein a total volume of the smaller modes is from 20 to 120 volume percent of the pore volume (1-PVF) of the largest mode in a randomly packed unimodal configuration. An Apollonian solids mixture refers to an Apollonian particle mixture comprising a multimodal solids mixture.

“Solids” and “solids volume” refer to all solids present in the slurry, including proppant and subproppant particles, including particulate thickeners such as colloids and submicron particles. “Solids-free” and similar terms generally exclude proppant and subproppant particles, except particulate thickeners such as colloids for the purposes of determining the viscosity of a “solids-free” fluid. “Proppant” refers to particulates that are used in well work-overs and treatments, such as hydraulic fracturing operations, to hold fractures open following the treatment, of a particle size mode or modes in the slurry having a weight average mean particle size greater than or equal to about 100 microns, e.g., 140 mesh particles correspond to a size of 105 microns, unless a different proppant size is indicated in the claim or a smaller proppant size is indicated in a claim depending therefrom. “Gravel” refers to particles used in gravel packing, and the term is synonymous with proppant as used herein. “Sub-proppant” or “subproppant” refers to particles or particle size or mode (including colloidal and submicron particles) having a smaller size than the proppant mode(s); references to “proppant” exclude subproppant particles and vice versa. In some embodiments, the sub-proppant mode or modes each have a weight average mean particle size less than or equal to about one-half of the weight average mean particle size of a smallest one of the proppant modes, e.g., a suspensive/stabilizing mode.

The proppant, when present, can be naturally occurring materials, such as sand grains. The proppant, when present, can also be man-made or specially engineered, such as coated (including resin-coated) sand, modulus of various nuts, high-strength ceramic materials like sintered bauxite, etc. In some embodiments, the proppant of the current application, when present, has a density greater than 2.45 g/mL, e.g., 2.5-2.8 g/mL, such as sand, ceramic, sintered bauxite or resin coated proppant. In some embodiments, the proppant of the current application, when present, has a density less than or equal to 2.45 g/mL, such as less than about 1.60 g/mL, less than about 1.50 g/mL, less than about 1.40 g/mL, less than about 1.30 g/mL, less than about 1.20 g/mL, less than 1.10 g/mL, or less than 1.00 g/mL, such as light/ultralight proppant from various manufacturers, e.g., hollow proppant.

In some embodiments, the energized carrier fluid may have a density, depending on the foam quality and the density of the liquid and gaseous components for example, from 0.05 to 1.2 g/mL, or less than 1.1 g/mL, or less than 1 g/mL, or less than 0.9 g/mL, or less than 0.8 g/mL, or less than 0.7 g/mL, or less than 0.6 g/mL, or less than 0.5 g/mL, or less than 0.4 g/mL, or less than 0.3 g/mL, or less than 0.2 g/mL, or less than 0.1 g/mL.

In some embodiments, the treatment fluid comprises an apparent specific gravity greater than 1.3, greater than 1.4, greater than 1.5, greater than 1.6, greater than 1.7, greater than 1.8, greater than 1.9, greater than 2, greater than 2.1, greater than 2.2, greater than 2.3, greater than 2.4, greater than 2.5, greater than 2.6, greater than 2.7, greater than 2.8, greater than 2.9, or greater than 3. The treatment fluid density can be selected by selecting the specific gravity and amount of the dispersed solids and/or adding a weighting solute to the aqueous phase, such as, for example, a compatible organic or mineral salt. In some embodiments, the aqueous or other liquid phase may have a specific gravity greater than 1, greater than 1.05, greater than 1.1, greater than 1.2, greater than 1.3, greater than 1.4, greater than 1.5, greater than 1.6, greater than 1.7, greater than 1.8, greater than 1.9, greater than 2, greater than 2.1, greater than 2.2, greater than 2.3, greater than 2.4, greater than 2.5, greater than 2.6, greater than 2.7, greater than 2.8, greater than 2.9, or greater than 3, etc. In some embodiments, the aqueous or other liquid phase may have a specific gravity less than 1. In embodiments, the weight of the treatment fluid can provide additional hydrostatic head pressurization in the wellbore at the perforations or other fracture location, and can also facilitate stability by lessening the density differences between the larger solids and the whole remaining fluid. In other embodiments, a low density proppant may be used in the treatment, for example, lightweight proppant (apparent specific gravity less than 2.65) having a density less than or equal to 2.5 g/mL, such as less than about 2 g/mL, less than about 1.8 g/mL, less than about 1.6 g/mL, less than about 1.4 g/mL, less than about 1.2 g/mL, less than 1.1 g/mL, or less than 1 g/mL. In other embodiments, the proppant or other particles in the slurry may have a specific gravity greater than 2.6, greater than 2.7, greater than 2.8, greater than 2.9, greater than 3, etc.

“Stable” or “stabilized” or similar terms refer to a stabilized treatment slurry (STS) wherein gravitational settling of the particles is inhibited such that no or minimal free liquid is formed, and/or there is no or minimal rheological variation among strata at different depths in the STS, and/or the slurry may generally be regarded as stable over the duration of expected STS storage and use conditions, e.g., an STS that passes a stability test or an equivalent thereof. In certain embodiments, stability can be evaluated following different settling conditions, such as for example static under gravity alone, or dynamic under a vibratory influence, or dynamic-static conditions employing at least one dynamic settling condition followed and/or preceded by at least one static settling condition.

The static settling test conditions can include gravity settling for a specified period, e.g., 24 hours, 48 hours, 72 hours, 96 hours, or the like, which are generally referred to with the respective shorthand notation “24 h-static”, “48 h-static” or “72 h static” or “92 h static.” Dynamic settling test conditions generally indicate the vibratory frequency and duration, e.g., 4h@15 Hz (4 hours at 15 Hz), 8 h@5 Hz (8 hours at 5 Hz), or the like. Dynamic settling test conditions are at a vibratory amplitude of 1 mm vertical displacement unless otherwise indicated. Dynamic-static settling test conditions will indicate the settling history preceding analysis including the total duration of vibration and the final period of static conditions, e.g., 4 h@15 Hz/20 h-static refers to 4 hours vibration followed by 20 hours static, or 8 h@15 Hz/10d-static refers to 8 hours total vibration, e.g., 4 hours vibration followed by 20 hours static followed by 4 hours vibration, followed by 10 days of static conditions. In the absence of a contrary indication, the designation “8 h@15 Hz/10d-static” refers to the test conditions of 4 hours vibration, followed by 20 hours static followed by 4 hours vibration, followed by 10 days of static conditions. In the absence of specified settling conditions, the settling condition is 72 hours static. The stability settling and test conditions are at 25° C. unless otherwise specified.

In certain embodiments, one stability test is referred to herein as the “8 h@15 Hz/10d-static STS stability test”, wherein a slurry sample is evaluated in a rheometer at the beginning of the test and compared against different strata of a slurry sample placed and sealed in a 152 mm (6 in.) diameter vertical gravitational settling column filled to a depth of 2.13 m (7 ft), vibrated at 15 Hz with a 1 mm amplitude (vertical displacement) two 4-hour periods the first and second settling days, and thereafter maintained in a static condition for 10 days (12 days total settling time). The 15 Hz/1 mm amplitude condition in this test is selected to correspond to surface transportation and/or storage conditions prior to the well treatment. At the end of the settling period the depth of any free water at the top of the column is measured, and samples obtained, in order from the top sampling port down to the bottom, through 25.4-mm sampling ports located on the settling column at 190 mm (6′3″), 140 mm (4′7″), 84 mm (2′9″) and 33 mm (1′1″), and rheologically evaluated for viscosity and yield stress as described above.

As used herein, a stabilized treatment slurry (STS) may meet at least one of the following conditions:
(1) the slurry has a low-shear viscosity equal to or greater than 1 Pa-s (5.11 s⁻¹, 25° C.);
(2) the slurry has a Herschel-Buckley (including Bingham plastic) yield stress (as determined in the manner described herein) equal to or greater than 1 Pa; or
(3) the largest particle mode in the slurry has a static settling rate less than 0.01 mm/hr; or
(4) the depth of any free fluid at the end of a 72-hour static settling test condition or an 8 h@15 Hz/10d-static dynamic settling test condition (4 hours vibration followed by 20 hours static followed by 4 hours vibration followed finally by 10 days of static conditions) is no more than 2% of total depth; or
(5) the apparent dynamic viscosity (25° C., 170 s⁻¹) across column strata after the 72-hour static settling test condition or the 8 h@15 Hz/10d-static dynamic settling test condition is no more than +/−20% of the initial dynamic viscosity; or
(6) the slurry solids volume fraction (SVF) across the column strata below any free water layer after the 72-hour static settling test condition or the 8 h@15 Hz/10d-static dynamic settling test condition is no more than 5% greater than the initial SVF; or
(7) the density across the column strata below any free water layer after the 72-hour static settling test condition or the 8 h@15 Hz/10d-static dynamic settling test condition is no more than 1% more than the initial density.

In embodiments, the depth of any free fluid at the end of the 8 h@15 Hz/10d-static dynamic settling test condition is no more than 2% of total depth, the apparent dynamic viscosity (25° C., 170 s-1) across column strata after the 8 h@15 Hz/10d-static dynamic settling test condition is no more than +/−20% of the initial dynamic viscosity, the slurry solids volume fraction (SVF) across the column strata below any free water layer after the 8 h@15 Hz/10d-static dynamic settling test condition is no more than 5% greater than the initial SVF, and the density across the column strata below any free water layer after the 8 h@15 Hz/10d-static dynamic settling test condition is no more than 1% of the initial density.

In some embodiments, the treatment slurry comprises at least one of the following stability indicia: (1) (a) an SVF on a gas-free basis of at least 0.4, or at least 0.5, or at least 0.6 up to SVF=PVF and/or (b) a DPVF of at least 0.4, or at least 0.5, or at least 0.6 up to DPVF=PVF; (2) a low-shear viscosity of at least 1 Pa-s (5.11 s⁻¹, 25° C.); (3) a yield stress (as determined herein) of at least 1 Pa; (4) an apparent viscosity of at least 50 mPa-s (170 s⁻¹, 25° C.); (5) a multimodal solids phase; (6) a solids phase having a PVF greater than 0.7; (7) a viscosifier selected from viscoelastic surfactants, in an amount ranging from 0.01 up to 7.2 g/L (60 ppt), and hydratable gelling agents in an amount ranging from 0.01 up to 4.8 g/L (40 ppt) based on the volume of fluid phase; (8) colloidal particles; (9) a particle-fluid density delta less than 1.6 g/mL, (e.g., particles having a specific gravity less than 2.65 g/mL, carrier fluid having a density greater than 1.05 g/mL or a combination thereof); (10) particles having an aspect ratio of at least 6; (11) ciliated or coated proppant; and (12) combinations thereof.

In some embodiments, the stabilized slurry comprises at least two of the stability indicia, such as for example, the SVF and/or DPVF of at least 0.4 and the low-shear viscosity of at least 1 Pa-s (5.11 s⁻¹, 25° C.); and optionally one or more of the yield stress of at least 1 Pa, the apparent viscosity of at least 50 mPa-s (170 s⁻¹, 25° C.), the multimodal solids phase, the solids phase having a PVF greater than 0.7, the viscosifier, the colloidal particles, the particle-fluid density delta less than 1.6 g/mL, the particles having an aspect ratio of at least 6, the ciliated or coated proppant, or a combination thereof.

In some embodiments, the stabilized slurry comprises at least three of the stability indicia, such as for example, the SVF and/or DPVF of at least 0.4, the low-shear viscosity of at least 1 Pa-s (5.11 s⁻¹, 25° C.) and the yield stress of at least 1 Pa; and optionally one or more of the apparent viscosity of at least 50 mPa-s (170 s⁻¹, 25° C.), the multimodal solids phase, the solids phase having a PVF greater than 0.7, the viscosifier, the colloidal particles, the particle-fluid density delta less than 1.6 g/mL, the particles having an aspect ratio of at least 6, the ciliated or coated proppant, or a combination thereof.

In some embodiments, the stabilized slurry comprises at least four of the stability indicia, such as for example, the SVF and/or DPVF of at least 0.4, the low-shear viscosity of at least 1 Pa-s (5.11 s⁻¹, 25° C.), the yield stress of at least 1 Pa and the apparent viscosity of at least 50 mPa-s (170 s⁻¹, 25° C.); and optionally one or more of the multimodal solids phase, the solids phase having a PVF greater than 0.7, the viscosifier, colloidal particles, the particle-fluid density delta less than 1.6 g/mL, the particles having an aspect ratio of at least 6, the ciliated or coated proppant, or a combination thereof.

In some embodiments, the stabilized slurry comprises at least five of the stability indicia, such as for example, the SVF of at least 0.4, the low-shear viscosity of at least 1 Pa-s (5.11 s⁻¹, 25° C.), the yield stress of at least 1 Pa, the apparent viscosity of at least 50 mPa-s (170 s⁻¹, 25° C.) and the multimodal solids phase, and optionally one or more of the solids phase having a PVF greater than 0.7, the viscosifier, colloidal particles, the particle-fluid density delta less than 1.6 g/mL, the particles having an aspect ratio of at least 6, the ciliated or coated proppant, or a combination thereof.

In some embodiments, the stabilized slurry comprises at least six of the stability indicia, such as for example, the SVF and/or DPVF of at least 0.4, the low-shear viscosity of at least 1 Pa-s (5.11 s⁻¹, 25° C.), the yield stress of at least 1 Pa, the apparent viscosity of at least 50 mPa-s (170 s⁻¹, 25° C.), the multimodal solids phase and the solids phase having a PVF greater than 0.7, and optionally one or more of the viscosifier, colloidal particles, the particle-fluid density delta less than 1.6 g/mL, the particles having an aspect ratio of at least 6, the ciliated or coated proppant, or a combination thereof.

In embodiments, the treatment slurry is formed (stabilized) by at least one of the following slurry stabilization operations: (1) introducing sufficient particles into the slurry or treatment fluid to increase the SVF (gas free basis) and/or DPVF of the treatment fluid to at least 0.4; (2) increasing a low-shear viscosity of the slurry or treatment fluid to at least 1 Pa-s (5.11 s⁻¹, 25° C.); (3) increasing a yield stress of the slurry or treatment fluid to at least 1 Pa; (4) increasing apparent viscosity of the slurry or treatment fluid to at least 50 mPa-s (170 s⁻¹, 25° C.); (5) introducing a multimodal solids phase into the slurry or treatment fluid; (6) introducing a solids phase having a PVF greater than 0.7 into the slurry or treatment fluid; (7) introducing into the slurry or treatment fluid a viscosifier selected from viscoelastic surfactants, e.g., in an amount ranging from 0.01 up to 7.2 g/L (60 ppt), and hydratable gelling agents, e.g., in an amount ranging from 0.01 up to 4.8 g/L (40 ppt) based on the volume of fluid phase; (8) introducing colloidal particles into the slurry or treatment fluid; (9) reducing a particle-fluid density delta to less than 1.6 g/mL (e.g., introducing particles having a specific gravity less than 2.65 g/mL, carrier fluid having a density greater than 1.05 g/mL or a combination thereof); (10) introducing particles into the slurry or treatment fluid having an aspect ratio of at least 6; (11) introducing ciliated or coated proppant into slurry or treatment fluid; and (12) combinations thereof. The slurry stabilization operations may be separate or concurrent, e.g., introducing a single viscosifier may also increase low-shear viscosity, yield stress, apparent viscosity, etc., or alternatively or additionally with respect to a viscosifier, separate agents may be added to increase low-shear viscosity, yield stress and/or apparent viscosity.

The techniques to stabilize particle settling in various embodiments herein may use any one, or a combination of any two or three, or all of these approaches, i.e., a manipulation of particle/fluid density, foam quality, carrier fluid viscosity, solids fraction, yield stress, and/or may use another approach. In embodiments, the treatment fluid is foamed or energized by introducing gas particles (bubbles) or foam into the treatment fluid. Various techniques for energizing or foaming a treatment fluid are known, for example, from U.S. Pat. No. 3,937,283, U.S. Pat. No. 7,345,012, and US 2012/0285694, which are hereby incorporated herein by reference. The energized fluid is generally prepared by preparing a slurry of the solid particulates which may include proppant, introducing a viscosifier, gelling agent and/or rheology modifier, e.g., a visoelastic surfactant, into the slurry, and then introducing a gas such as air, nitrogen, carbon dioxide or the like, with or without mixing to disperse the gas into the treatment fluid. In embodiments, the viscoelastic surfactant may be nonionic, anionic, cationic, zwitterionic or amphoteric, such as those described, for example, in U.S. Pat. Nos. 6,433,277 and 6,703,352, which are hereby incorporated herein by reference. Betaines and quaternary amines are representative examples of surfactants used in some embodiments. A foam stabilizer may also be present in the carrier fluid in some embodiments, such as, for example, a partially hydrolyzed polyvinyl ester, a partially hydrolyzed polyacrylate or a foam stabilizer of formula (I):

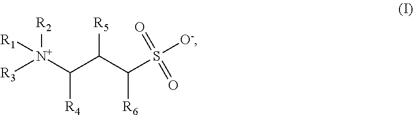

wherein R₁ is an alkylamido group or a branched or linear alkyl group; R₂ and R₃ are individually hydrogen or a methyl group; R₄, R₅ and R₆ are individually hydrogen or a hydroxy group, with the proviso that at least one of R₄, R₅ or R₆ is a hydroxyl group; wherein the alkyl group has greater than about 10 carbon atoms.

In embodiments, the stabilized slurry is formed by at least two of the slurry stabilization operations, such as, for example, increasing the SVF and/or DPVF and increasing the low-shear viscosity of the treatment fluid, and optionally one or more of increasing the yield stress, increasing the apparent viscosity, introducing the multimodal solids phase, introducing the solids phase having the PVF greater than 0.7, introducing the viscosifier, introducing the colloidal particles, reducing the particle-fluid density delta, introducing the particles having the aspect ratio of at least 6, introducing the ciliated or coated proppant or a combination thereof.

In embodiments, the stabilized slurry is formed by at least three of the slurry stabilization operations, such as, for example, increasing the SVF and/or DPVF, increasing the low-shear viscosity and introducing the multimodal solids phase, and optionally one or more of increasing the yield stress, increasing the apparent viscosity, introducing the solids phase having the PVF greater than 0.7, introducing the viscosifier, introducing the colloidal particles, reducing the particle-fluid density delta, introducing the particles having the aspect ratio of at least 6, introducing the ciliated or coated proppant or a combination thereof.

In embodiments, the stabilized slurry is formed by at least four of the slurry stabilization operations, such as, for example, increasing the SVF and/or DPVF, increasing the low-shear viscosity, increasing the yield stress and increasing apparent viscosity, and optionally one or more of introducing the multimodal solids phase, introducing the solids phase having the PVF greater than 0.7, introducing the viscosifier, introducing colloidal particles, reducing the particle-fluid density delta, introducing particles into the treatment fluid having the aspect ratio of at least 6, introducing the ciliated or coated proppant or a combination thereof.

In embodiments, the stabilized slurry is formed by at least five of the slurry stabilization operations, such as, for example, increasing the SVF and/or DPVF, increasing the low-shear viscosity, increasing the yield stress, increasing the apparent viscosity and introducing the multimodal solids phase, and optionally one or more of introducing the solids phase having the PVF greater than 0.7, introducing the viscosifier, introducing colloidal particles, reducing the particle-fluid density delta, introducing particles into the treatment fluid having the aspect ratio of at least 6, introducing the ciliated or coated proppant or a combination thereof.

Decreasing the density difference between the particle and the carrier fluid may be done in embodiments by employing porous particles, including particles with an internal porosity, i.e., hollow particles. However, the porosity may also have a direct influence on the mechanical properties of the particle, e.g., the elastic modulus, which may also decrease significantly with an increase in porosity. In certain embodiments employing particle porosity, care should be taken so that the crush strength of the particles exceeds the maximum expected stress for the particle, e.g., in the embodiments of proppants placed in a fracture the overburden stress of the subterranean formation in which it is to be used should not exceed the crush strength of the proppants.

In embodiments, yield stress fluids, and also fluids having a high low-shear viscosity, are used to retard the motion of the carrier fluid and thus retard particle settling. The gravitational stress exerted by the particle at rest on the fluid beneath it must generally exceed the yield stress of the fluid to initiate fluid flow and thus settling onset. For a single particle of density 2.7 g/mL and diameter of 600 settling in a yield stress fluid phase of 1 g/mL, the critical fluid yield stress, i.e., the minimum yield stress to prevent settling onset, in this example is 1 Pa. The critical fluid yield stress might be higher for larger particles, including particles with size enhancement due to particle clustering, aggregation or the like.

Increasing carrier fluid viscosity in a Newtonian fluid also proportionally increases the resistance of the carrier fluid motion. In some embodiments, the fluid carrier has a lower limit of apparent dynamic viscosity, determined at 170 s⁻¹ and 25° C., of at least about 0.1 mPa-s, or at least about 1 mPa-s, or at least about 10 mPa-s, or at least about 25 mPa-s, or at least about 50 mPa-s, or at least about 75 mPa-s, or at least about 100 mPa-s, or at least about 150 mPa-s. A disadvantage of increasing the viscosity is that as the viscosity increases, the friction pressure for pumping the slurry generally increases as well. In some embodiments, the fluid carrier has an upper limit of apparent dynamic viscosity, determined at 170 s⁻¹ and 25° C., of less than about 300 mPa-s, or less than about 150 mPa-s, or less than about 100 mPa-s, or less than about 75 mPa-s, or less than about 50 mPa-s, or less than about 25 mPa-s, or less than about 10 mPa-s. In embodiments, the fluid phase viscosity ranges from any lower limit to any higher upper limit.

In some embodiments, an agent may both viscosify and impart yield stress characteristics, and in further embodiments may also function as a friction reducer to reduce friction pressure losses in pumping the treatment fluid and/or as a foam stabilizer to inhibit phase separation. In embodiments, the liquid phase is essentially free of viscosifier or comprises a viscosifier in an amount ranging from 0.01 up to 2.4 g/L (0.08-20 lb/1000 gals) of the fluid phase. The viscosifier can be a viscoelastic surfactant (VES) or a hydratable gelling agent such as a polysaccharide, which may be crosslinked. When using viscosifiers and/or yield stress fluids, it may be useful to consider the need for and if necessary implement a clean-up procedure, i.e., removal or inactivation of the viscosifier and/or yield stress fluid during or following the treatment procedure, since fluids with viscosifiers and/or yield stresses may present clean up difficulties in some situations or if not used correctly. In certain embodiments, clean up can be effected using a breaker(s). In some embodiments, the slurry is stabilized for storage and/or pumping or other use at the surface conditions, and clean-up is achieved downhole at a later time and at a higher temperature, e.g., for some formations, the temperature difference between surface and downhole can be significant and useful for triggering degradation of the viscosifier, the particles, a yield stress agent or characteristic, and/or a breaker. Thus in some embodiments, breakers that are either temperature sensitive or time sensitive, either through delayed action breakers or delay in mixing the breaker into the slurry, can be useful.

In certain embodiments, the fluid may be stabilized by introducing colloidal particles into the treatment fluid, such as, for example, colloidal silica, which may function as a gellant and/or thickener.

In addition or as an alternative to increasing the viscosity of the carrier fluid (with or without density manipulation), increasing the volume fraction of the particles in the treatment fluid can also hinder movement of the carrier fluid. Where the particles are not deformable, the particles interfere with the flow of the fluid around the settling particle to cause hindered settling. The addition of a large volume fraction of particles can be complicated, however, by increasing fluid viscosity and pumping pressure, and increasing the risk of loss of fluidity of the slurry in the event of carrier fluid losses. In some embodiments, the treatment fluid has a lower limit of apparent dynamic viscosity, determined at 170 s⁻¹ and 25° C., of at least about 1 mPa-s, or at least about 10 mPa-s, or at least about 25 mPa-s, or at least about 50 mPa-s, or at least about 75 mPa-s, or at least about 100 mPa-s, or at least about 150 mPa-s, or at least about 300 mPa-s, and an upper limit of apparent dynamic viscosity, determined at 170 s⁻¹ and 25° C., of less than about 500 mPa-s, or less than about 300 mPa-s, or less than about 150 mPa-s, or less than about 100 mPa-s, or less than about 75 mPa-s, or less than about 50 mPa-s, or less than about 25 mPa-s, or less than about 10 mPa-s. In embodiments, the treatment fluid viscosity ranges from any lower limit to any higher upper limit.

In embodiments, the treatment fluid may be stabilized by introducing sufficient particles into the treatment fluid to increase the SVF of the treatment fluid, e.g., to at least 0.5. In a powder or particulated medium, the packed volume fraction (PVF) is defined as the volume of space occupied by the particles (the absolute volume) divided by the bulk volume, i.e., the total volume of the particles plus the void space between them:

PVF=Particle volume/(Particle volume+Non-particle Volume)=1−φ

For the purposes of calculating PVF and slurry solids volume fraction (SVF) herein, the particle volume includes the volume of any colloidal and/or submicron particles.

Here, the porosity, φ, is the void fraction of the powder pack. Unless otherwise specified the PVF of a particulated medium is determined in the absence of overburden or other compressive force that would deform the packed solids. The packing of particles (in the absence of overburden) is a purely geometrical phenomenon. Therefore, the PVF depends only on the size and the shape of particles. The most ordered arrangement of monodisperse spheres (spheres with exactly the same size in a compact hexagonal packing) has a PVF of 0.74. However, such highly ordered arrangements of particles rarely occur in industrial operations. Rather, a somewhat random packing of particles is prevalent in oilfield treatment. Unless otherwise specified, particle packing in the current application means random packing of the particles. A random packing of the same spheres has a PVF of 0.64. In other words, the randomly packed particles occupy 64% of the bulk volume, and the void space occupies 36% of the bulk volume. A higher PVF can be achieved by preparing blends of particles that have more than one particle size and/or a range(s) of particle sizes. The smaller particles can fit in the void spaces between the larger ones.

The PVF in embodiments can therefore be increased by using a multimodal particle mixture, for example, coarse, medium and fine particles in specific volume ratios, where the fine particles can fit in the void spaces between the medium-size particles, and the medium size particles can fit in the void space between the coarse particles. For some embodiments of two consecutive size classes or modes, the ratio between the mean particle diameters (d₅₀) of each mode may be between 7 and 10. In such cases, the PVF can increase up to 0.95 in some embodiments. By blending coarse particles (such as proppant) with other particles selected to increase the PVF, only a minimum amount of fluid phase (such as water) is needed to render the treatment fluid pumpable. Such concentrated suspensions (i.e. slurry) tend to behave as a porous solid and may shrink under the force of gravity. This is a hindered settling phenomenon as discussed above and, as mentioned, the extent of solids-like behavior generally increases with the slurry solid volume fraction (SVF), which is given as

SVF=Solid particle volume/(Solid particle volume+Liquid volume);

or where the particles may include solids, dispersed liquids or gas particles/droplets, with the dispersed particle volume fraction (DPVF), which is given as:

DPVF=Particle volume/(Particle volume+Liquid volume).

It follows that proppant or other large particle mode settling in multimodal embodiments can if desired be minimized independently of the viscosity of the continuous phase. Therefore, in some embodiments little or no viscosifier and/or yield stress agent, e.g., a gelling agent, in excess of that used for foam stability, is required to inhibit settling and achieve particle transport, such as, for example, less than 2.4 g/L, less than 1.2 g/L, less than 0.6 g/L, less than 0.3 g/L, less than 0.15 g/L, less than 0.08 g/L, less than 0.04 g/L, less than 0.2 g/L or less than 0.1 g/L of viscosifier may be present in the STS.

It is helpful for an understanding of the current application to consider the amounts of particles present in the slurries of various embodiments of the treatment fluid. The minimum amount of fluid phase necessary to make a homogeneous slurry blend is the amount required to just fill all the void space in the PVF with the continuous phase, i.e., when SVF=PVF or DPVF=PVF. However, this blend may not be flowable since all the solids and liquid may be locked in place with no room for slipping and mobility. In flowable system embodiments, SVF or DPVF may be lower than PVF, e.g., SVF/PVF 0.99 or DPVF/PVF 0.99. In this condition, in a stabilized treatment slurry, essentially all the voids are filled with excess liquid to increase the spacing between particles so that the particles can roll or flow past each other. In some embodiments, the higher the PVF, the lower the SVF/PVF or DPVF/PVF ratio should be to obtain a flowable slurry.

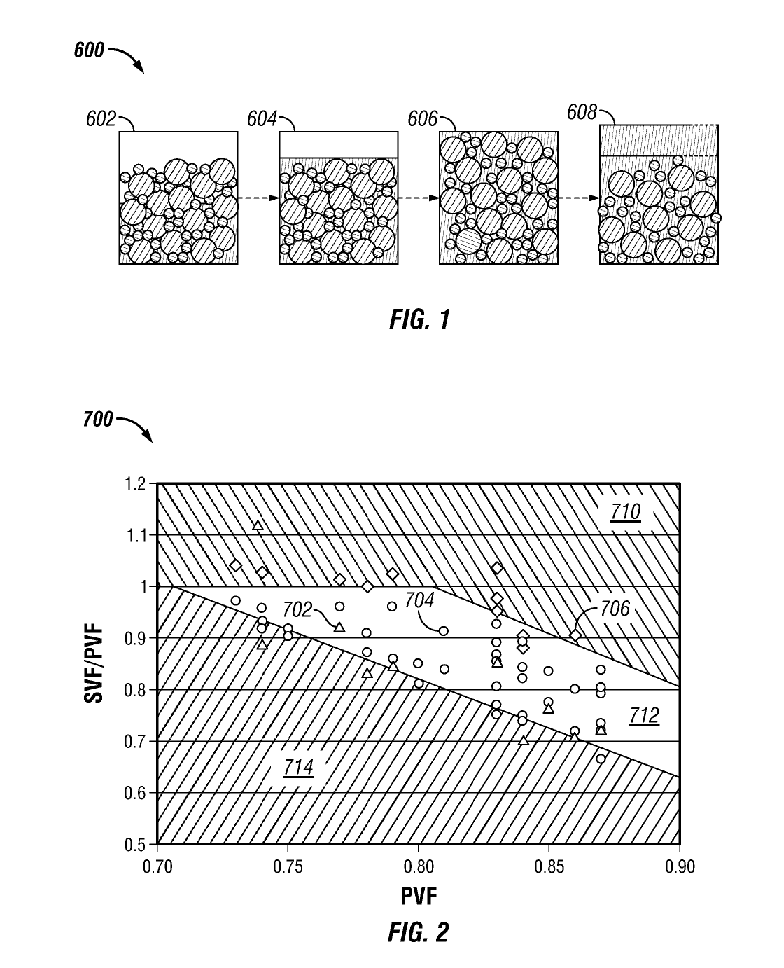

FIG. 1 shows a slurry state progression chart for a system 600 having a particle mix with added fluid phase. The first fluid 602 does not have enough liquid added to fill the pore spaces of the particles, or in other words the SVF/PVF is greater than 1.0. The first fluid 602 is not flowable. The second fluid 604 has just enough fluid phase to fill the pore spaces of the particles, or in other words the SVF/PVF is equal to 1.0. Testing determines whether the second fluid 604 is flowable and/or pumpable, but a fluid with an SVF/PVF of 1.0 is generally not flowable or barely flowable due to an excessive apparent viscosity and/or yield stress. The third fluid 606 has slightly more fluid phase than is required to fill the pore spaces of the particles, or in other words the SVF/PVF is just less than 1.0. A range of SVF/PVF values less than 1.0 will generally be flowable and/or pumpable or mixable, and if it does not contain too much fluid phase (and/or contains an added viscosifier) the third fluid 606 is stable. The values of the range of SVF/PVF values that are pumpable, flowable, mixable, and/or stable are dependent upon, without limitation, the specific particle mixture, fluid phase viscosity, the PVF of the particles, and the density of the particles. Simple laboratory testing of the sort ordinarily performed for fluids before fracturing treatments can readily determine the stability (e.g., the STS stability test as described herein) and flowability (e.g., apparent dynamic viscosity at 170 s⁻¹ and 25° C. of less than about 10,000 mPa-s).

The fourth fluid 608 shown in FIG. 1 has more fluid phase than the third fluid 606, to the point where the fourth fluid 608 is flowable but is not stabilized and settles, forming a layer of free fluid phase at the top (or bottom, depending upon the densities of the particles in the fourth fluid 608). The amount of free fluid phase and the settling time over which the free fluid phase develops before the fluid is considered unstable are parameters that depend upon the specific circumstances of a treatment, as noted above. For example, if the settling time over which the free liquid develops is greater than a planned treatment time, then in one example the fluid would be considered stable. Other factors, without limitation, that may affect whether a particular fluid remains stable include the amount of time for settling and flow regimes (e.g. laminar, turbulent, Reynolds number ranges, etc.) of the fluid flowing in a flow passage of interest or in an agitated vessel, e.g., the amount of time and flow regimes of the fluid flowing in the wellbore, fracture, etc., and/or the amount of fluid leakoff occurring in the wellbore, fracture, etc. A fluid that is stable for one fracturing treatment may be unstable for a second fracturing treatment. The determination that a fluid is stable at particular conditions may be an iterative determination based upon initial estimates and subsequent modeling results. In some embodiments, the stabilized treatment fluid passes the STS test described herein.

FIG. 2 shows a data set 700 of various essentially Newtonian fluids without any added viscosifiers and without any yield stress, which were tested for the progression of slurry state on a plot of SVF/PVF as a function of PVF. The fluid phase in the experiments was water and the solids had specific gravity 2.6 g/mL. Data points 702 indicated with a triangle were values that had free water in the slurry, data points 704 indicated with a circle were slurriable fluids that were mixable without excessive free water, and data points 706 indicated with a diamond were not easily mixable liquid-solid mixtures. The data set 700 includes fluids prepared having a number of discrete PVF values, with liquid added until the mixture transitions from not mixable to a slurriable fluid, and then further progresses to a fluid having excess settling. At an example for a solids mixture with a PVF value near PVF=0.83, it was observed that around an SVF/PVF value of 0.95 the fluid transitions from an unmixable mixture to a slurriable fluid. At around an SVF/PVF of 0.7, the fluid transitions from a stable slurry to an unstable fluid having excessive settling. It can be seen from the data set 700 that the compositions can be defined approximately into a non-mixable region 710, a slurriable region 712, and a settling region 714.

FIG. 2 shows the useful range of SVF and PVF for slurries in embodiments without gelling agents. In some embodiments, the SVF is less than the PVF, or the ratio SVF/PVF is within the range from about 0.6 or about 0.65 to about 0.95 or about 0.98. Where the liquid phase has a viscosity less than 10 mPa-s or where the treatment fluid is water essentially free of thickeners, in some embodiments PVF is greater than 0.72 and a ratio of SVF/PVF is greater than about 1-2.1*(PVF−0.72) for stability (non-settling). Where the PVF is greater than 0.81, in some embodiments a ratio of SVF/PVF may be less than 1-2.1*(PVF−0.81) for mixability (flowability). Adding thickening or suspending agents, or solids that perform this function such as calcium carbonate or colloids, i.e., to increase viscosity and/or impart a yield stress, in some embodiments allows fluids otherwise in the settling area 714 embodiments (where SVF/PVF is less than or equal to about 1-2.1*(PVF−0.72)) to also be useful as an STS or in applications where a non-settling, slurriable/mixable slurry is beneficial, e.g., where the treatment fluid has a viscosity greater than 10 mPa-s, greater than 25 mPa-s, greater than 50 mPa-s, greater than 75 mPa-s, greater than 100 mPa-s, greater than 150 mPa-s, or greater than 300 mPa-s; and/or a yield stress greater than 0.1 Pa, greater than 0.5 Pa, greater than 1 Pa, greater than 10 Pa or greater than 20 Pa.

Introducing high-aspect ratio particles into the treatment fluid, e.g., particles having an aspect ratio of at least 6, represents additional or alternative embodiments for stabilizing the treatment fluid. Examples of such non-spherical particles include, but are not limited to, fibers, flakes, discs, rods, stars, etc., as described in, for example, U.S. Pat. No. 7,275,596, US20080196896, which are hereby incorporated herein by reference. In certain embodiments, introducing ciliated or coated proppant into the treatment fluid may stabilize or help stabilize the treatment fluid.

Proppant or other particles coated with a hydrophilic polymer can make the particles behave like larger particles and/or more tacky particles in an aqueous medium. The hydrophilic coating on a molecular scale may resemble ciliates, i.e., proppant particles to which hairlike projections have been attached to or formed on the surfaces thereof. Herein, hydrophilically coated proppant particles are referred to as “ciliated or coated proppant.” Hydrophilically coated proppants and methods of producing them are described, for example, in WO 2011-050046, U.S. Pat. No. 5,905,468, U.S. Pat. No. 8,227,026 and U.S. Pat. No. 8,234,072, which are hereby incorporated herein by reference.

In some additional or alternative embodiment, the energized STS system may have the benefit that the smaller particles, especially any immiscible liquid/emulsion particles and/or gas/foam particles, in the voids of the larger particles act as slip additives like mini-ball bearings, allowing the solid particles to roll past each other without any requirement for relatively large spaces between particles. This property can be demonstrated in some embodiments by the flow of the STS through a relatively small slot orifice with respect to the maximum diameter of the largest particle mode of the STS, e.g., a slot orifice less than 6 times the largest particle diameter, without bridging at the slot, i.e., the slurry flowed out of the slot has an SVF that is at least 90% of the SVF of the STS supplied to the slot. In contrast, the slickwater technique requires a ratio of perforation diameter to proppant diameter of at least 6, and additional enlargement for added safety to avoid screen out usually dictates a ratio of at least 8 or 10 and does not allow high proppant loadings.

In embodiments, the flowability of the energized STS through narrow flow passages such as perforations and fractures is similarly facilitated, allowing a smaller ratio of perforation diameter and/or fracture width to proppant size that still provides transport of the proppant through the perforation and/or to the tip of the fracture, i.e., improved flowability of the proppant in the fracture, e.g., in relatively narrow fracture widths, and improved penetration of the proppant-filled fracture extending away from the wellbore into the formation. These embodiments provide a relatively longer proppant-filled fracture prior to screenout relative to slickwater or high-viscosity fluid treatments.

As used herein, the “minimum slot flow test ratio” refers to a test wherein an approximately 100 mL slurry specimen is loaded into a fluid loss cell with a bottom slot opened to allow the test slurry to come out, with the fluid pushed by a piston using water or another hydraulic fluid supplied with an ISCO pump or equivalent at a rate of 20 mL/min, wherein a slot at the bottom of the cell can be adjusted to different openings at a ratio of slot width to largest particle mode diameter less than 6, and wherein the maximum slot flow test ratio is taken as the lowest ratio observed at which 50 vol % or more of the slurry specimen flows through the slot before bridging and a pressure increase to the maximum gauge pressure occurs. In some embodiments, the STS has a minimum slot flow test ratio less than 6, or less than 5, or less than 4, or less than 3, or a range of 2 to 6, or a range of 3 to 5.

Because of the relatively low water content (high SVF or DPVF) of some embodiments of the STS, fluid loss from the STS may be a concern where flowability is important and DPVF should at least be held lower than PVF, or considerably lower than PVF in some other embodiments. In conventional hydraulic fracturing treatments, there are two main reasons that a high volume of fluid and high amount of pumping energy have to be used, namely proppant transport and fluid loss. To carry the proppant to a distant location in a fracture, the treatment fluid has to be sufficiently turbulent (slickwater) or viscous (gelled fluid). Even so, only a low concentration of proppant is typically included in the treatment fluid to avoid settling and/or screen out. Moreover, when a fluid is pumped into a formation to initiate or propagate a fracture, the fluid pressure will be higher than the formation pressure, and the liquid in the treatment fluid is constantly leaking off into the formation. This is especially the case for slickwater operations. The fracture creation is a balance between the fluid loss and new volume created. As used herein, “fracture creation” encompasses either or both the initiation of fractures and the propagation or growth thereof. If the liquid injection rate is lower than the fluid loss rate, the fracture cannot be grown and becomes packed off. Therefore, traditional hydraulic fracturing operations are not efficient in creating fractures in the formation.

In some embodiments of the STS herein where the SVF is high, even a small loss of carrier fluid may result in a loss of flowability of the treatment fluid, and in some embodiments it is therefore undertaken to guard against excessive fluid loss from the treatment fluid, at least until the fluid and/or proppant reaches its ultimate destination. In embodiments, the energized STS may have an excellent tendency to retain fluid and thereby maintain flowability, i.e., it has a low leakoff rate into a porous or permeable surface with which it may be in contact. According to some embodiments of the current application, the treatment fluid is formulated to have very good leakoff control characteristics, i.e., fluid retention to maintain flowability. The good leak control can be achieved by including a leakoff control system in the treatment fluid of the current application, which may comprise one or more of high viscosity, low viscosity, a fluid loss control agent, selective construction of a multimodal particle system in a multimodal fluid (MMF) or in a stabilized multimodal fluid (SMMF), or the like, or any combination thereof. Further, in some embodiments, leakoff control is also enhanced by the presence of the foam particles in the energized STS.

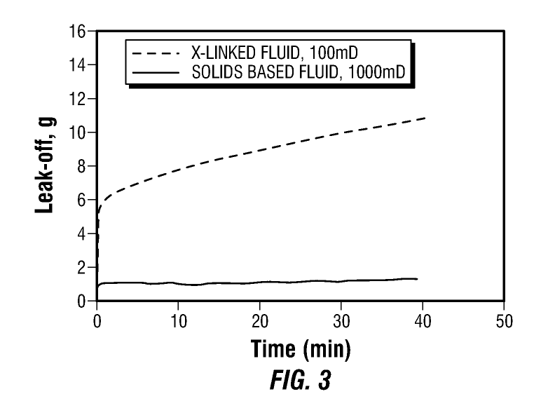

As discussed in the examples below and as shown in FIG. 3, the leakoff of embodiments of a treatment fluid of the current application was an order of magnitude less than that of a conventional crosslinked fluid. It should be noted that the leakoff characteristic of a treatment fluid is dependent on the permeability of the formation to be treated. Therefore, a treatment fluid that forms a low permeability filter cake with good leakoff characteristic for one formation may or may not be a treatment fluid with good leakoff for another formation. Conversely, certain embodiments of the treatment fluids of the current application form low permeability filter cakes that have substantially superior leakoff characteristics such that they are not dependent on the substrate permeability provided the substrate permeability is higher than a certain minimum, e.g., at least 1 mD.

In certain embodiments herein, the STS comprises a packed volume fraction (PVF) greater than a slurry solids volume fraction (SVF), and has a spurt loss value (Vspurt) less than 10 vol % of a fluid phase of the stabilized treatment fluid or less than 50 vol % of an excess fluid phase (Vspurt<0.50*(PVF−SVF), where the “excess fluid phase” is taken as the amount of fluid in excess of the amount present at the condition SVF=PVF, i.e., excess fluid phase=PVF−SVF).

In some embodiments the treatment fluid comprises an STS also having a very low leakoff rate. For example, the total leakoff coefficient may be about 3×10⁻⁴ m/min^{1/2} (10⁻³ ft/min^{1/2}) or less, or about 3×10⁻⁵ m/min^{1/2} (10⁻⁴ ft/min^{1/2}) or less. As used herein, Vspurt and the total leak-off coefficient Cw are determined by following the static fluid loss test and procedures set forth in Section 8-8.1, “Fluid loss under static conditions,” in Reservoir Stimulation, 3^{rd} Edition, Schlumberger, John Wiley & Sons, Ltd., pp. 8-23 to 8-24, 2000, in a filter-press cell using ceramic disks (FANN filter disks, part number 210538) saturated with 2% KC solution and covered with filter paper and test conditions of ambient temperature (25° C.), a differential pressure of 3.45 MPa (500 psi), 100 ml sample loading, and a loss collection period of 60 minutes, or an equivalent testing procedure. In some embodiments of the current application, the treatment fluid has a fluid loss value of less than 10 g in 30 min when tested on a core sample with 1000 mD porosity. In some embodiments of the current application, the treatment fluid has a fluid loss value of less than 8 g in 30 min when tested on a core sample with 1000 mD porosity. In some embodiments of the current application, the treatment fluid has a fluid loss value of less than 6 g in 30 min when tested on a core sample with 1000 mD porosity. In some embodiments of the current application, the treatment fluid has a fluid loss value of less than 2 g in 30 min when tested on a core sample with 1000 mD porosity.

The unique low to no fluid loss property allows the treatment fluid to be pumped at a low rate or pumping stopped (static) with a low risk of screen out. In embodiments, the low fluid loss characteristic may be obtained by including a leak-off control agent, such as, for example, particulated loss control agents (in some embodiments less than 1 micron or 0.05-0.5 microns), graded PSD or multimodal particles, polymers, latex, fiber, etc. As used herein, the terms leak-off control agent, fluid loss control agent and similar refer to additives that inhibit fluid loss from the slurry into a permeable formation.

As representative leakoff control agents, which may be used alone or in a multimodal fluid, there may be mentioned latex dispersions, water soluble polymers, submicron particulates, particulates with an aspect ratio higher than 1, or higher than 6, combinations thereof and the like, such as, for example, crosslinked polyvinyl alcohol microgel. The fluid loss agent can be, for example, a latex dispersion of polyvinylidene chloride, polyvinyl acetate, polystyrene-co-butadiene; a water soluble polymer such as hydroxyethylcellulose (HEC), guar, copolymers of polyacrylamide and their derivatives; particulate fluid loss control agents in the size range of 30 nm to 1 micron, such as γ-alumina, colloidal silica, CaCO₃, SiO₂, bentonite etc.; particulates with different shapes such as glass fibers, flakes, films; and any combination thereof or the like. Fluid loss agents can if desired also include or be used in combination with acrylamido-methyl-propane sulfonate polymer (AMPS). In embodiments, the leak-off control agent comprises a reactive solid, e.g., a hydrolysable material such as PGA, PLA or the like; or it can include a soluble or solubilizable material such as a wax, an oil-soluble resin, or another material soluble in hydrocarbons, or calcium carbonate or another material soluble at low pH; and so on. In embodiments, the leak-off control agent comprises a reactive solid selected from ground quartz, oil soluble resin, degradable rock salt, clay, zeolite or the like. In other embodiments, the leak-off control agent comprises one or more of magnesium hydroxide, magnesium carbonate, magnesium calcium carbonate, calcium carbonate, aluminum hydroxide, calcium oxalate, calcium phosphate, aluminum metaphosphate, sodium zinc potassium polyphosphate glass, and sodium calcium magnesium polyphosphate glass, or the like.

The treatment fluid may additionally or alternatively include, without limitation, friction reducers, clay stabilizers, biocides, crosslinkers, breakers, corrosion inhibitors, and/or proppant flowback control additives. The treatment fluid may further include a product formed from degradation, hydrolysis, hydration, chemical reaction, or other process that occur during preparation or operation.

In certain embodiments herein, the STS may be prepared by combining the particles, such as proppant if present and subproppant, the carrier liquid and any additives to form a proppant-containing treatment fluid; and stabilizing the proppant-containing treatment fluid. The combination and stabilization may occur in any order or concurrently in single or multiple stages in a batch, semi-batch or continuous operation. For example, in some embodiments, the base fluid may be prepared from the subproppant particles, the carrier liquid and other additives, and then the base fluid combined with the proppant.

The treatment fluid may be prepared on location, e.g., at the wellsite when and as needed using conventional treatment fluid blending equipment.

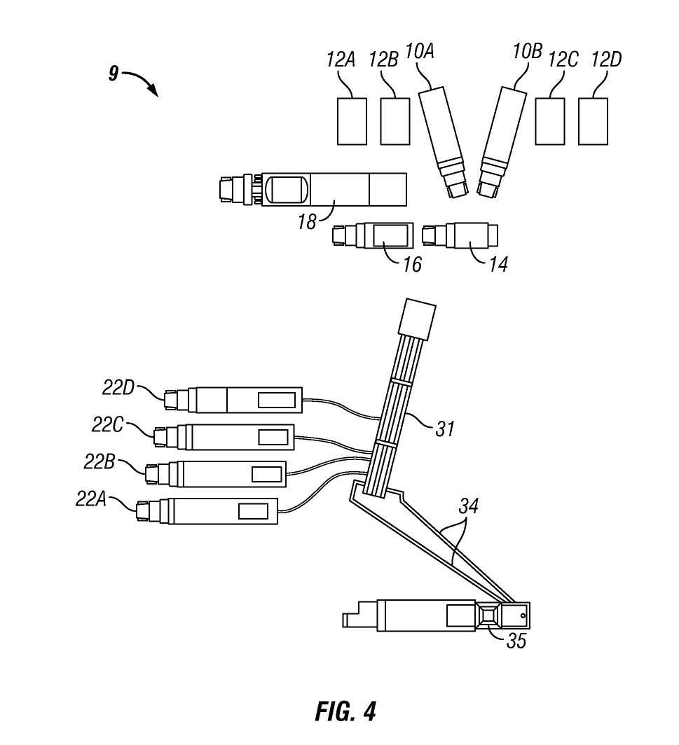

FIG. 4 shows a wellsite equipment configuration 10 for a fracture treatment job according to some embodiments using the principles disclosed herein, for a land-based fracturing operation. The proppant is contained in sand trailers 11A, 11B. Water tanks 12A, 12B, 12C, 12D are arranged along one side of the operation site. Hopper 14 receives sand from the sand trailers 10A, 10B and distributes it into the mixer truck 16. Blender 18 is provided to blend the carrier medium (such as brine, viscosified fluids, etc.) with the proppant, i.e., “on the fly,” and then the slurry is discharged to manifold 20. Additionally, gas or immiscible fluid may be added at such stage to improve the foam quality. The final mixed and blended slurry, also called frac fluid, is then transferred to the pump trucks 22A, 22B, 22C, 22D, and routed at treatment pressure through treating line 24 to rig 26, and then pumped downhole. This configuration eliminates the additional mixer truck(s), pump trucks, blender(s), manifold(s) and line(s) normally required for slickwater fracturing operations, and the overall footprint is considerably reduced.

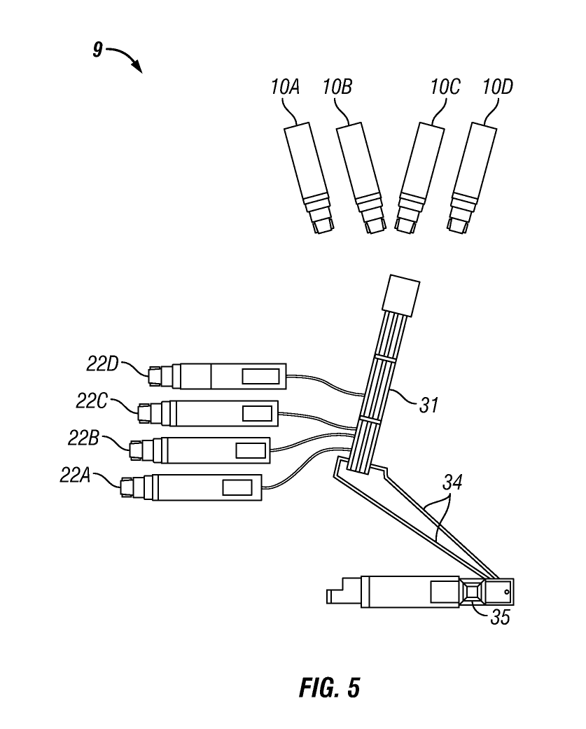

FIG. 5 shows further embodiments of the wellsite equipment configuration with the additional feature of delivery of pump-ready treatment fluid delivered to the wellsite in trailers 10A to 10D and further elimination of the mixer 26, hopper 14, and/or blender 18. In some embodiments the treatment fluid is prepared offsite and pre-mixed with proppant and other additives, or with some or all of the additives except proppant, such as in a system described in co-pending co-assigned patent applications with application Ser. No. 13/415,025, filed on Mar. 8, 2012, and application Ser. No. 13/487,002, filed on Jun. 1, 2012, the entire contents of which are incorporated herein by reference in their entireties. In the present context, the “pump-ready” fluid may be supplemented with gas or immiscible fluid to improve the foam quality. As used herein, the term “pump-ready” should be understood broadly. In certain embodiments, a pump-ready treatment fluid means the treatment fluid is fully prepared and can be pumped downhole without being further processed. In some other embodiments, the pump-ready treatment fluid means the fluid is substantially ready to be pumped downhole except that a further dilution may be needed before pumping or one or more minor additives need to be added before the fluid is pumped downhole. In such an event, the pump-ready treatment fluid may also be called a pump-ready treatment fluid precursor. In some further embodiments, the pump-ready treatment fluid may be a fluid that is substantially ready to be pumped downhole except that certain incidental procedures are applied to the treatment fluid before pumping, such as low-speed agitation, heating or cooling under exceptionally cold or hot climate, etc.

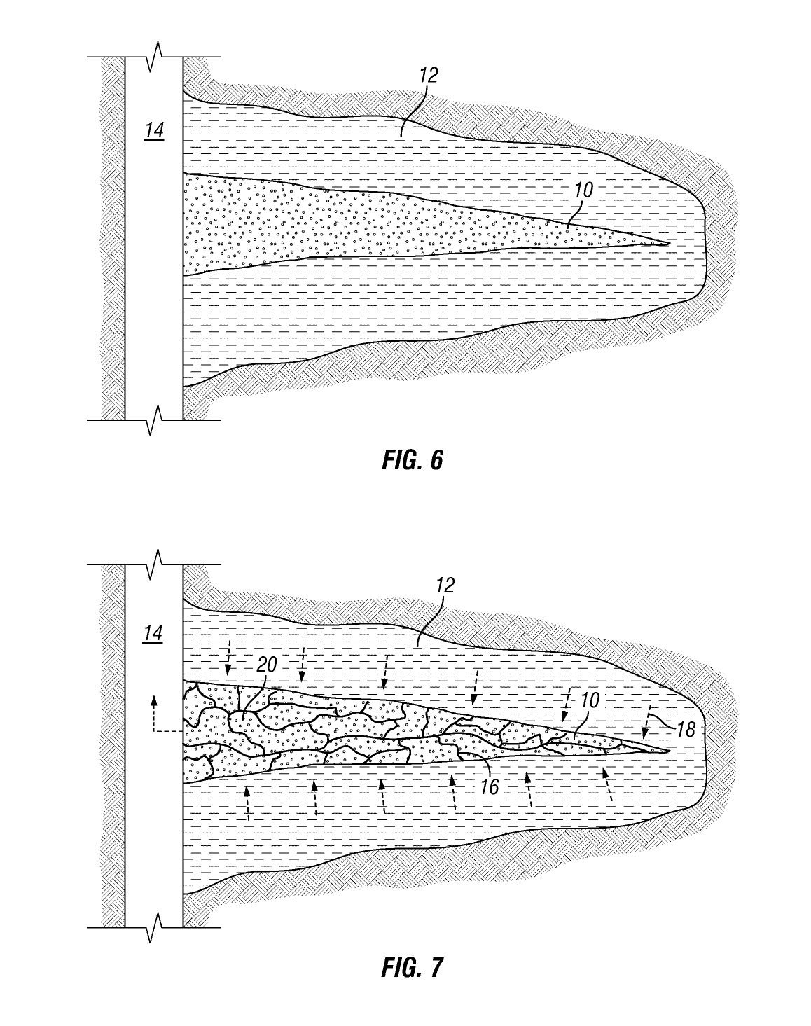

In some embodiments, as shown schematically in FIG. 6, the fracture 10 formed in the formation 12, e.g., a gas shale formation, is propped via the wellbore 14 with an energized STS. In some embodiments, leak-off takes place during the time of the fracture closure, e.g., into natural fractures and into the formation matrix. The presence of foam in conjunction with a viscosifying agent, gelling agent and/or rheology modifier, may in some embodiments aid in reducing leakoff into the matrix and microfractures. Once the fracture is closed, if the pressure differential between the reservoir and the wellbore is high enough, it leads the reservoir fluid, e.g., gas, to flow through the filter cake and through the proppant pack in the presence of the foam. In some embodiments as shown in FIG. 7, channels 16 with high permeability appear and gas 18 flows through the proppant pack 20 toward the wellbore 14. To observe this phenomenon and improve its efficiency, the energized STS fluid may in some embodiments be designed such that the proppant pack conductivity is increased after placement by the presence of the energizing gas.

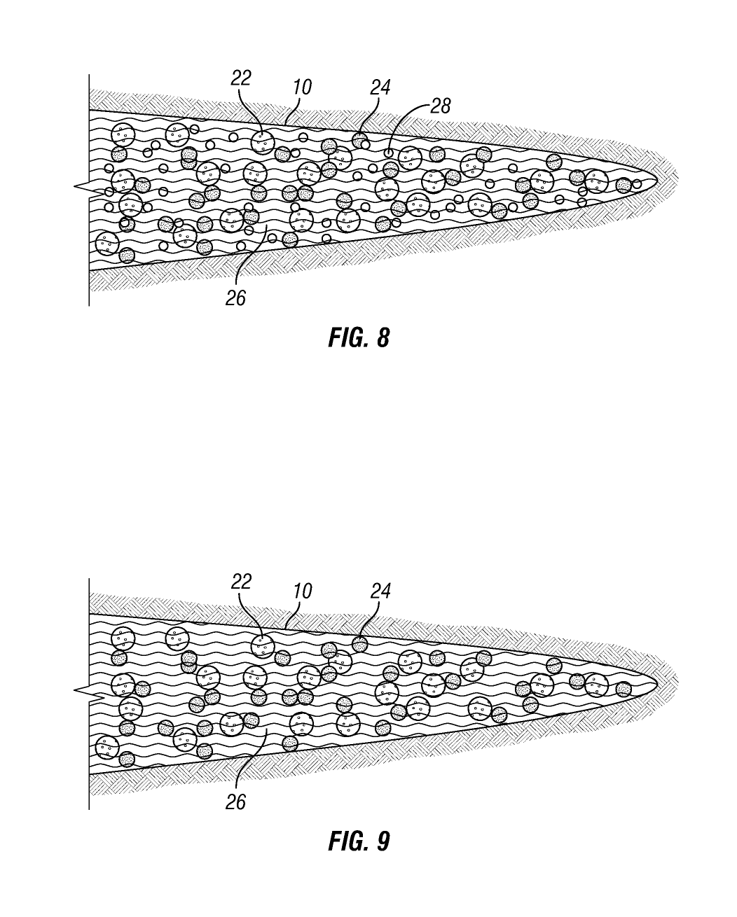

In some embodiments as shown in FIG. 8, an energized STS, with relatively large proppant 22 and small proppant 24 modes (multimodal), and a carrier fluid 26 that is based on surfactant gelling agent, is foamed with gas phase bubbles 28 and placed in a fracture 10. The foam is generated by mixing the slurry with an energizing gas, resulting in a targeted foam quality. The foamed fluid as a carrier fluid has a continuous liquid, e.g., aqueous, phase 26 with foam bubbles 28 as the dispersed phase. The foam particles (bubbles) 28 will coalesce with time or may go into solution under pressure and subsequently in some embodiments may be simply produced during flowback, leaving the multimodal proppant 22, 24 as shown schematically in FIG. 9. The gas in foamed fluid may possess some energy that will aid in flowback in some embodiments. In some embodiments, a higher conductivity will be achieved because the foam functions as a stabilizing particle during proppant placement, but unlike an inert solid may be easily removed to enlarge the interstices and improve conductivity through the proppant pack. In particular embodiments, if the flowback fluid from the reservoir is gas such as methane, then the conductivity of the proppant pack placed with foam may be higher due to the presence of similar fluid phases in the formation matrix (reservoir) and the proppant pack in the fracture.

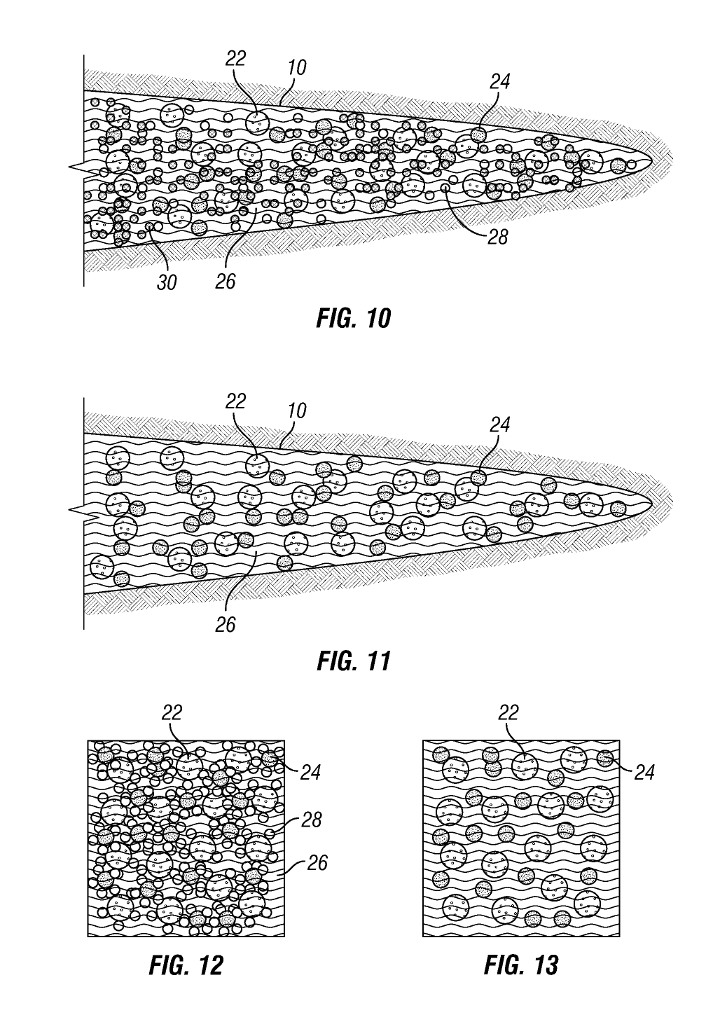

In some embodiments, an energized STS comprises multimodal proppants and a liquid emulsion, which can be oil droplets in a continuous water phase or water droplets in a continuous oil phase, or a water in oil in water emulsion, etc. In embodiments, when the energized STS with the liquid emulsion is formulated at the surface and pumped downhole into the fracture, the conductivity of the fracture is enhanced. As illustrated in FIG. 10, during placement in the fracture 10, the slurry in some embodiments may thus comprise sand/proppants 22, 24 of different size distributions, an aqueous carrier fluid 26, foam bubbles 28 and emulsion droplets 30. The multimodal particles in these embodiments include inert solids 22, 24, emulsion droplets 30 and foam bubbles 28, the latter two of which may also be considered as deformable particles giving rise to an effectively increased PVF where the liquid emulsion and foam are considered as packing particles. After placement and removal of the foam and the emulsion droplets from the proppant pack during flowback as shown in FIG. 11, the conductivity of the pack is enhanced relative to a similar proppant pack placed with inert solid subproppant particles in place of the emulsion droplets and foam bubbles. It was observed that substituting inert particles with foam bubbles increase the pack permeability by two to three orders of magnitude.

In fracturing with high solids STS, a high proppant pack conductivity relative to unimodal proppant is in many embodiments the most difficult parameter to achieve due to the presence of close packing of the inert solids. To enhance the conductivity according to embodiments of the present disclosure, one or more of the inert subproppant solids and preferably the smaller sized solids may be replaced by the gas bubbles by foaming the STS fluid and maintaining the Apollonian packing approach. For instance, in some embodiments, the presence of gas through foaming the STS either maintains or enhances the rheological properties (viscosity, flowability) and stability properties. Such properties are highly desired at the surface both during storage and during pumping of the slurry. Once this foamed STS is pumped under pressure and placed within the fracture as shown in FIG. 12, the gas bubbles 28 may shrink under pressure, and additionally the gas may dissolve into the liquid phase, effectively removing the gas particles so that only large inert particles (proppant particles) 22, 24 remain, as seen in FIG. 13, thus enhancing conductivity. With foamed STS in some embodiments, there is no requirement to degrade the solid particles to enhance the conductivity due to the presence of foam.

In certain embodiments herein, for example in gravel packing, fracturing and frac-and-pack operations, the STS comprises proppant and a fluid phase at a volumetric ratio of the fluid phase (Vfluid) to the proppant (Vprop) equal to or less than 3. In embodiments, Vfluid/Vprop is equal to or less than 2.5. In embodiments, Vfluid/Vprop is equal to or less than 2. In embodiments, Vfluid/Vprop is equal to or less than 1.5. In embodiments, Vfluid/Vprop is equal to or less than 1.25. In embodiments, Vfluid/Vprop is equal to or less than 1. In embodiments, Vfluid/Vprop is equal to or less than 0.75. In embodiments, Vfluid/Vprop is equal to or less than 0.7. In embodiments, Vfluid/Vprop is equal to or less than 0.6. In embodiments, Vfluid/Vprop is equal to or less than 0.5. In embodiments, Vfluid/Vprop is equal to or less than 0.4. In embodiments, Vfluid/Vprop is equal to or less than 0.35. In embodiments, Vfluid/Vprop is equal to or less than 0.3. In embodiments, Vfluid/Vprop is equal to or less than 0.25. In embodiments, Vfluid/Vprop is equal to or less than 0.2. In embodiments, Vfluid/Vprop is equal to or less than 0.1. In embodiments, Vfluid/Vprop may be sufficiently high such that the STS is flowable. In some embodiments, the ratio V_{fluid}/Vₚᵣₒₚ is equal to or greater than 0.05, equal to or greater than 0.1, equal to or greater than 0.15, equal to or greater than 0.2, equal to or greater than 0.25, equal to or greater than 0.3, equal to or greater than 0.35, equal to or greater than 0.4, equal to or greater than 0.5, or equal to or greater than 0.6, or within a range from any lower limit to any higher upper limit mentioned above.

Nota bene, the STS may optionally comprise subproppant particles in the whole fluid which are not reflected in the Vfluid/Vprop ratio, which is merely a ratio of the liquid phase (sans solids and gas) volume to the proppant volume. This ratio is useful, in the context of the STS where the liquid phase is aqueous, as the ratio of water to proppant, i.e., Vwater/Vprop. In contrast, the “ppa” designation refers to pounds proppant added per gallon of base fluid (liquid plus subproppant particles), which can be converted to an equivalent volume of proppant added per volume of base fluid if the specific gravity of the proppant is known, e.g., 2.65 in the case of quartz sand embodiments, in which case 1 ppa=0.12 kg/L=45 mUL; whereas “ppg” (pounds of proppant per gallon of treatment fluid) and “ppt” (pounds of additive per thousand gallons of treatment fluid) are based on the volume of the treatment fluid (liquid plus proppant and subproppant particles), which for quartz sand embodiments (specific gravity=2.65) also convert to 1 ppg=1000 ppt=0.12 kg/L=45 mL/L. The ppa, ppg and ppt nomenclature and their metric or SI equivalents are useful for considering the weight ratios of proppant or other additive(s) to base fluid (water or other fluid and subproppant) and/or to treatment fluid (water or other fluid plus proppant plus subproppant). The ppt nomenclature is generally used in embodiments in reference to the concentration by weight of low concentration additives other than proppant, e.g., 1 ppt=0.12 g/L.

In embodiments, the proppant-containing treatment fluid comprises 0.27 L or more of proppant volume per liter of treatment fluid (corresponding to 720 g/L (6 ppg) in embodiments where the proppant has a specific gravity of 2.65), or 0.36 L or more of proppant volume per liter of treatment fluid (corresponding to 960 g/L (8 ppg) in embodiments where the proppant has a specific gravity of 2.65), or 0.4 L or more of proppant volume per liter of treatment fluid (corresponding to 1.08 kg/L (9 ppg) in embodiments where the proppant has a specific gravity of 2.65), or 0.44 L or more of proppant volume per liter of treatment fluid (corresponding to 1.2 kg/L (10 ppg) in embodiments where the proppant has a specific gravity of 2.65), or 0.53 L or more of proppant volume per liter of treatment fluid (corresponding to 1.44 kg/L (12 ppg) in embodiments where the proppant has a specific gravity of 2.65), or 0.58 L or more of proppant volume per liter of treatment fluid (corresponding to 1.56 kg/L (13 ppg) in embodiments where the proppant has a specific gravity of 2.65), or 0.62 L or more of proppant volume per liter of treatment fluid (corresponding to 1.68 kg/L (14 ppg) in embodiments where the proppant has a specific gravity of 2.65), or 0.67 L or more of proppant volume per liter of treatment fluid (corresponding to 1.8 kg/L (15 ppg) in embodiments where the proppant has a specific gravity of 2.65), or 0.71 L or more of proppant volume per liter of treatment fluid (corresponding to 1.92 kg/L (16 ppg) in embodiments where the proppant has a specific gravity of 2.65).

As used herein, in some embodiments, “high proppant loading” means, on a mass basis, more than 1.0 kg proppant added per liter of whole fluid including any sub-proppant particles (8 ppa,), or on a volumetric basis, more than 0.36 L proppant added per liter of whole fluid including any sub-proppant particles, or a combination thereof. In some embodiments, the treatment fluid comprises more than 1.1 kg proppant added per liter of whole fluid including any sub-proppant particles (9 ppa), or more than 1.2 kg proppant added per liter of whole fluid including any sub-proppant particles (10 ppa), or more than 1.44 kg proppant added per liter of whole fluid including any sub-proppant particles (12 ppa), or more than 1.68 kg proppant added per liter of whole fluid including any sub-proppant particles (14 ppa), or more than 1.92 kg proppant added per liter of whole fluid including any sub-proppant particles (16 ppa), or more than 2.4 kg proppant added per liter of fluid including any sub-proppant particles (20 ppa), or more than 2.9 kg proppant added per liter of fluid including any sub-proppant particles (24 ppa). In some embodiments, the treatment fluid comprises more than 0.45 L proppant added per liter of whole fluid including any sub-proppant particles, or more than 0.54 L proppant added per liter of whole fluid including any sub-proppant particles, or more than 0.63 L proppant added per liter of whole fluid including any sub-proppant particles, or more than 0.72 L proppant added per liter of whole fluid including any sub-proppant particles, or more than 0.9 L proppant added per liter of whole fluid including any sub-proppant particles.

In some embodiments, the water content in the fracture treatment fluid formulation is low, e.g., less than 30% by volume of the treatment fluid, the low water content enables low overall water volume to be used, relative to a slickwater fracture job for example, to place a similar amount of proppant or other solids, with low to essentially zero fluid infiltration into the formation matrix and/or with low to zero flowback after the treatment, and less chance for fluid to enter the aquifers and other intervals. The low flowback leads to less delay in producing the stimulated formation, which can be placed into production with a shortened clean up stage or in some cases immediately without a separate flowback recovery operation.

In embodiments where the fracturing treatment fluid also has a low viscosity and a relatively high DPVF, e.g., 40, 50, 60 or 70% or more, the fluid can in some surprising embodiments be very flowable (low viscosity) and can be pumped using standard well treatment equipment. With a high volumetric ratio of proppant to water, e.g., greater than about 1.0, these embodiments represent a breakthrough in water efficiency in fracture treatments. Embodiments of a low water content in the treatment fluid certainly results in correspondingly low fluid volumes to infiltrate the formation, and importantly, no or minimal flowback during fracture cleanup and when placed in production. In the solid pack, as well as on formation surfaces and in the formation matrix, water can be retained due to a capillary and/or surface wetting effect. In embodiments, the solids pack obtained from an STS with multimodal solids can retain a larger proportion of water than conventional proppant packs, further reducing the amount of water flowback. In some embodiments, the water retention capability of the fracture-formation system can match or exceed the amount of water injected into the formation, and there may thus be no or very little water flowback when the well is placed in production.

In some specific embodiments, the proppant laden treatment fluid comprises an excess of a low viscosity continuous fluid phase, e.g., a liquid phase, and a multimodal particle phase, e.g. solids phase, comprising high proppant loading with one or more proppant modes for fracture conductivity and at least one sub-proppant mode to facilitate proppant injection. As used herein an excess of the continuous fluid phase implies that the continuous liquid volume fraction in a slurry (1-DPVF) exceeds the void volume fraction (1-PVF) of the solids in the slurry, i.e., DPVF<PVF. Solids in the slurry in embodiments may comprise both proppant and one or more sub-proppant particle modes. In embodiments, the continuous fluid phase is a liquid phase. In embodiments, dispersed particle phases include foam bubbles and may optionally include emulsion droplets.

In some embodiments, the STS is prepared by combining the proppant and a fluid phase having a viscosity less than 300 mPa-s (170 s⁻¹, 25 C) to form the proppant-containing treatment fluid, and stabilizing the proppant-containing treatment fluid. Energizing and stabilizing the treatment fluid is described above. In some embodiments, the proppant-containing treatment fluid is prepared to comprise a viscosity between 0.1 and 300 mPa-s (170 s⁻¹, 25 C) and a yield stress between 1 and 20 Pa (2.1-42 lb_{f}/ft²). In some embodiments, the proppant-containing treatment fluid comprises 0.36 L or more of proppant volume per liter of proppant-containing treatment fluid (8 ppa proppant equivalent where the proppant has a specific gravity of 2.6), a viscosity between 0.1 and 300 mPa-s (170 s⁻¹, 25 C), a solids phase having a packed volume fraction (PVF) greater than 0.72, a slurry solids volume fraction (SVF) less than the PVF and a ratio of SVF/PVF greater than about 1-2.1*(PVF−0.72).

In some embodiments, e.g., for delivery of a fracturing stage, the STS comprises a volumetric proppant/treatment fluid ratio (including proppant and sub-proppant solids) in a main stage of at least 0.27 L/L (6 ppg at sp.gr. 2.65), or at least 0.36 L/L (8 ppg), or at least 0.44 L/L (10 ppg), or at least 0.53 L/L (12 ppg), or at least 0.58 L/L (13 ppg), or at least 0.62 L/L (14 ppg), or at least 0.67 UL (15 ppg), or at least 0.71 UL (16 ppg).

In some embodiments, the hydraulic fracture treatment may comprise an overall volumetric proppant/water ratio of at least 0.13 L/L (3 ppg at sp. gr. 2.65), or at least 0.18 L/L (4 ppg), or at least 0.22 L/L (5 ppg), or at least 0.26 L/L (6 ppg), or at least 0.38 UL (8 ppg), or at least 0.44 L/L (10 ppg), or at least 0.53 UL (12 ppg), or at least 0.58 L/L (13 ppg). Note that subproppant particles are not a factor in the determination of the proppant water ratio.

In some embodiments, e.g., a front-end stage STS, the slurry comprises a stabilized solids mixture comprising a particulated leakoff control system (which may include solid and/or liquid particles, e.g., submicron particles, colloids, micelles, PLA dispersions, latex systems, etc.) and a solids volume fraction (SVF) of at least 0.4.

In some embodiments, e.g., a pad stage STS, the slurry comprises viscosifier in an amount to provide a viscosity in the pad stage of greater than 300 mPa-s, determined on a whole fluid basis at 170 s⁻¹ and 25° C.

In some embodiments, e.g., a flush stage STS, the slurry comprises a proppant-free slurry comprising a stabilized solids mixture comprising a particulated leakoff control system (which may include solid and/or liquid particles, e.g., submicron particles, colloids, micelles, PLA dispersions, latex systems, etc.) and a solids volume fraction (SVF) of at least 0.4. In other embodiments, the proppant-containing fracturing stage may be used with a flush stage comprising a first substage comprising viscosifier and a second substage comprising slickwater. The viscosifier may be selected from viscoelastic surfactant systems, hydratable gelling agents (optionally including crosslinked gelling agents), and the like. In other embodiments, the flush stage comprises an overflush equal to or less than 3200 L (20 42-gal bbls), equal to or less than 2400 L (15 bbls), or equal to or less than 1900 L (12 bbls).

In some embodiments, the proppant stage comprises a continuous single injection of the STS free of spacers.

In some embodiments the STS comprises a total proppant volume injected into the wellbore or to be injected into the wellbore of at least 800 liters. In some embodiments, the total proppant volume is at least 1600 liters. In some embodiments, the total proppant volume is at least 3200 liters. In some embodiments, the total proppant volume is at least 8000 liters. In some embodiments, the total proppant volume is at least 80,000 liters. In some embodiments, the total proppant volume is at least 800,000 liters. The total proppant volume injected into the wellbore or to be injected into the wellbore is typically not more than 16 million liters.

Sometimes it is desirable to stop pumping a treatment fluid during a hydraulic fracturing operation, such as for example, when an emergency shutdown is required. For example, there may be a complete failure of surface equipment, there may be a near wellbore screenout, or there may be a natural disaster due to weather, fire, earthquake, etc. However, with unstabilized fracturing fluids such as slickwater, the proppant suspension will be inadequate at zero pumping rate, and proppant may screen out in the wellbore and/or fail to get placed in the fracture. With slickwater it is usually impossible to resume the fracturing operation without first cleaning the settled proppant out of the wellbore, often using coiled tubing or a workover rig. There is some inefficiency in fluidizing proppant out of the wellbore with coiled tubing, and a significant amount of a specialized clean out fluid will be used to entrain the proppant and lift it to surface. After the clean out, a decision will need to be made whether to repeat the treatment or just leave that portion of the wellbore sub-optimally treated. In contrast, in embodiments herein, the treatment fluid is stabilized and the operator can decide to resume and/or complete the fracture operation, or to circulate the STS (and any proppant) out of the well bore. By stabilizing the treatment fluid to practically eliminate particle settling, the treatment fluid possesses the characteristics of excellent proppant conveyance and transport even when static.

Due to the stability of the treatment fluid in some embodiments herein, the proppant will remain suspended and the fluid will retain its fracturing properties during the time the pumping is interrupted. In some embodiments herein, a method comprises combining at least 0.36, at least 0.4, or at least 0.45 L of proppant per liter of base fluid to form a proppant-containing treatment fluid, stabilizing the proppant-containing treatment fluid, pumping the STS, e.g., injecting the proppant-containing treatment fluid into a subterranean formation and/or creating a fracture in the subterranean formation with the treatment fluid, stopping pumping of the STS thereby stranding the treatment fluid in the wellbore, and thereafter resuming pumping of the treatment fluid, e.g., to inject the stranded treatment fluid into the formation and continue the fracture creation, and/or to circulate the stranded treatment fluid out of the wellbore as an intact plug with a managed interface between the stranded treatment fluid and a displacing fluid. Circulating the treatment fluid out of the wellbore can be achieved optionally using coiled tubing or a workover rig, if desired, but in embodiments the treatment fluid will itself suspend and convey all the proppant out of the wellbore with high efficiency. In some embodiments, the method may include managing the interface between the treatment fluid and any displacing fluid, such as, for example, matching density and viscosity between the treatment and displacing fluids, using a wiper plug or pig, using a gelled pill or fiber pill or the like, to prevent density and viscous instabilities.

In some embodiments, the treatment provides production-related features resulting from a low water content in the treatment fluid, such as, for example, less infiltration into the formation and/or less water flowback. Formation damage occurs whenever the native reservoir conditions are disturbed. A significant source of formation damage during hydraulic fracturing occurs when the fracturing fluids contact and infiltrate the formation. Measures can be taken to reduce the potential for formation damage, including adding salts to improve the stability of fines and clays in the formation, addition of scale inhibitors to limit the precipitation of mineral scales caused by mixing of incompatible brines, addition of surfactants to minimize capillary blocking of the tight pores and so forth. There are some types of formation damage for which additives are not yet available to solve. For example, some formations will be mechanically weakened upon coming in contact with water, referred to herein as water-sensitive formations. Thus, it is desirable to significantly reduce the amount of water that can infiltrate the formation during a well completion operation.

Very low water slurries and water free slurries according to certain embodiments disclosed herein offer a pathway to significantly reduce water infiltration and the collateral formation damage that may occur. Low water STS minimizes water infiltration relative to slick water fracture treatments by two mechanisms. First, the water content in the STS can be less than about 40% of slickwater per volume of respective treatment fluid, and the STS can provide in some embodiments more than a 90% reduction in the amount of water used per volume or weight of proppant placed in the formation. Second, the solids pack in the STS in embodiments including subproppant particles retains more water than conventional proppant packs so that less water is released from the STS into the formation.

After fracturing, water flowback plagues the prior art fracturing operations. Load water recovery typically characterizes the initial phase of well start up following a completion operation. In the case of horizontal wells with massive hydraulic fractures in unconventional reservoirs, 15 to 30% of the injected hydraulic fracturing fluid is recovered during this start up phase. At some point, the load water recovery rate becomes very low and the produced gas rate high enough for the well to be directed to a gas pipeline to market. We refer to this period of time during load water recovery as the fracture clean up phase. It is normal for a well to clean up for several days before being connected to a gas sales pipeline. The flowback water must be treated and/or disposed of, and delays pipeline production. A low water content slurry according to embodiments herein can significantly reduce the volume and/or duration, or even eliminate this fracture clean up phase. Fracturing fluids normally are lost into the formation by various mechanisms including filtration into the matrix, imbibition into the matrix, wetting the freshly exposed new fracture face, loss into natural fractures. A low water content slurry will become dry with only a small loss of its water into the formation by these mechanisms, leaving in some embodiments no or very little free water to be required (or able) to flow back during the fracture clean up stage. The advantages of zero or reduced flowback include reduced operational cost to manage flowback fluid volumes, reduced water treatment cost, reduced time to put well to gas sales, reduction of problematic waste that will develop by injected waters solubilizing metals, naturally occurring radioactive materials, etc.

There have also been concerns expressed by the general public that hydraulic fracturing fluid may find some pathway into a potable aquifer and contaminate it. Although proper well engineering and completion design, and fracture treatment execution will prevent any such contamination from occurring, if it were to happen by an unforeseen accident, a slickwater system will have enough water and mobility in an aquifer to migrate similar to a salt water plume. A low water STS in embodiments may have a 90% reduction in available water per mass of proppant such that any contact with an aquifer, should it occur, will have much less impact than slickwater.

Subterranean formations are heterogeneous, with layers of high, medium, and low permeability strata interlaced. A hydraulic fracture that grows to the extent that it encounters a high permeability zone will suddenly experience a high leakoff area that will attract a disproportionately large fraction of the injected fluid significantly changing the geometry of the created hydraulic fracture possibly in an undesirable manner. A hydraulic fracturing fluid that would automatically plug a high leakoff zone is useful in that it would make the fracture execution phase more reliable and probably ensure the fracture geometry more closely resembles the designed geometry (and thus production will be closer to that expected). One feature of embodiments of an STS is that it will dehydrate and become an immobile mass (plug) upon losing more than 25% of the water it is formulated with. As an STS in embodiments only contains up to 50% water by volume, then it will only require a loss of a total of 12.5% of the STS treatment fluid volume in the high fluid loss affected area to become an immobile plug and prevent subsequent fluid loss from that area; or in other embodiments only contains up to 40% water by volume, requiring a loss of a total of 10% of the STS treatment fluid volume to become immobile. A slick water system would need to lose around 90% or 95% of its total volume to dehydrate the proppant into an immobile mass.

Sometimes, during a hydraulic fracture treatment, the surface treating pressure will approach the maximum pressure limit for safe operation. The maximum pressure limit may be due to the safe pressure limitation of the wellhead, the surface treating lines, the casing, or some combination of these items. One common response to reaching an upper pressure limit is to reduce the pumping rate. However, with ordinary fracturing fluids, the proppant suspension will be inadequate at low pumping rates, and proppant may fail to get placed in the fracture. The stabilized fluids in some embodiments of this disclosure, which can be highly stabilized and practically eliminate particle settling, possess the characteristic of excellent proppant conveyance and transport even when static. Thus, some risk of treatment failure is mitigated since a fracture treatment can be pumped to completion in some embodiments herein, even at very low pump rates should injection rate reduction be necessary to stay below the maximum safe operating pressure during a fracture treatment with the stabilized treatment fluid.

In some embodiments, the injection of the treatment fluid of the current application can be stopped all together (i.e. at an injection rate of 0 bbl/min). Due to the excellent stability of the treatment fluid, very little or no proppant settling occurs during the period of 0 bbl/min injection. Well intervention, treatment monitoring, equipment adjustment, etc. can be carried out by the operator during this period of time. The pumping can be resumed thereafter. Accordingly, in some embodiments of the current application, there is provided a method comprising injecting a proppant laden treatment fluid into a subterranean formation penetrated by a wellbore, initiating or propagating a fracture in the subterranean formation with the treatment fluid, stopping injecting the treatment fluid for a period of time, restarting injecting the treatment fluid to continue the initiating or propagating of the fracture in the subterranean formation.

In some embodiments, the treatment and system may achieve the ability to fracture using a carbon dioxide proppant stage treatment fluid. Carbon dioxide is normally too light and too thin (low viscosity) to carry proppant in a slurry useful in fracturing operations. However, in an energized STS fluid, carbon dioxide may be useful in the liquid phase, especially where the proppant stage treatment fluid also comprises a particulated fluid loss control agent. In embodiments, the liquid phase comprises at least 10 wt % carbon dioxide, at least 50 wt % carbon dioxide, at least 60 wt % carbon dioxide, at least 70 wt % carbon dioxide, at least 80 wt % carbon dioxide, at least 90 wt % carbon dioxide, or at least 95 wt % carbon dioxide. The carbon dioxide-containing liquid phase may alternatively or additionally be present in any pre-pad stage, pad stage, front-end stage, flush stage, post-flush stage, or any combination thereof.

Various jetting and jet cutting operations in embodiments are significantly improved by the non-settling and solids carrying abilities of the STS. Jet perforating and jet slotting are embodiments for the STS, wherein the proppant is replaced with an abrasive or erosive particle. Multi-zone fracturing systems using a locating sleeve/polished bore and jet cut opening are embodiments.

Accordingly, the present invention provides the following embodiments:

E1. A well treatment fluid, comprising: a stabilized, flowable slurry comprising an Apollonian particle mixture comprising solids dispersed in an energized carrier fluid with at least one additive selected from the group consisting of viscosifiers, gelling agents and rheological agents.
E2. The well treatment fluid according to Embodiment E1 wherein the energized carrier fluid has a foam quality from 5 to 95%.
E3. The well treatment fluid according to Embodiment E1 or Embodiment E2 wherein the energized carrier fluid comprises foam.
E4. The well treatment fluid according to any one of Embodiments E1 to E3, wherein the solids mixture comprises a first proppant mode having a particle size greater than 100 microns and a second proppant mode having a particle size smaller than the first proppant mode.
E5. The well treatment fluid according to any one of Embodiments E1 to E4, wherein the carrier fluid further comprises a dispersed liquid phase immiscible in a continuous liquid phase.
E6. The well treatment fluid according to any one of Embodiments E1 to E5, comprising a dispersed particle volume fraction (DPVF) of at least 40%, wherein the dispersed particles comprise solids, foam and optionally liquid particles.
E7. The well treatment fluid according to any one of Embodiments E1 to E6, wherein the carrier fluid is energized with carbon dioxide.
E8. The well treatment fluid according to any one of Embodiments E1 to E7, wherein the carrier fluid is energized with air, helium, argon, nitrogen, or hydrocarbon gases (such as methane, ethane, propane, butane, pentane, hexane, heptane . . . ), and mixtures thereof.
E9. The well treatment fluid according to any one of Embodiments E1 to E8, wherein the carrier fluid is energized with produced gas.
E10. The well treatment fluid according to any one of Embodiments E1 to E9, wherein the carrier fluid is energized with natural gas.
E11. The well treatment fluid according to any one of Embodiments E1 to E10, wherein the solids comprise proppant.
E12. The well treatment fluid according to any one of Embodiments E1 to E11, wherein the solids comprise at least two particle size modes comprising at least one proppant mode.
E13. The well treatment fluid according to any one of Embodiments E1 to E12, wherein the particle mixture comprises subproppant foam particles.
E14. The well treatment fluid according to any one of Embodiments E1 to E13, comprising two proppant modes.
E15. The well treatment fluid according to any one of Embodiments E1 to E14, further comprising at least one of the stability indicia selected from: (1) a dispersed particle volume fraction (DPVF) of at least 0.4; (2) a low-shear viscosity of at least 1 Pa-s (5.11 s⁻¹, 25° C.); (3) a yield stress of at least 1 Pa; (4) an apparent viscosity of at least 50 mPa-s (170 s⁻¹, 25° C.); (5) a multimodal solids phase; (6) a solids phase having a packed volume fraction (PVF) greater than 0.7; (7) a viscosifier selected from viscoelastic surfactants, in an amount ranging from 0.01 up to 7.2 g/L (60 ppt), and hydratable gelling agents in an amount ranging from 0.01 up to 4.8 g/L (40 ppt) based, on the volume of fluid phase; (8) colloidal particles; (9) a solid particle-fluid density delta less than 1.6 g/mL; (10) particles having an aspect ratio of at least 6; (11) ciliated or coated proppant; and (12) combinations thereof.
E16. The well treatment fluid according to any one of Embodiments E1 to E15, further comprising a dispersed particle volume fraction (DPVF) of at least 0.4.
E17. The well treatment fluid according to any one of Embodiments E1 to E16, further comprising a dispersed particle volume fraction (DPVF) of at least 0.5.
E18. The well treatment fluid according to any one of Embodiments E1 to E17, further comprising a dispersed particle volume fraction (DPVF) of at least 0.6.
E19. The well treatment fluid according to any one of Embodiments E1 to E18, further comprising a low-shear viscosity of at least 1 Pa-s (5.11 s⁻¹, 25° C.).
E20. The well treatment fluid according to any one of Embodiments E1 to E19, further comprising a yield stress of at least 1 Pa.
E21. The well treatment fluid according to any one of Embodiments E1 to E20, further comprising an apparent viscosity of at least 50 mPa-s (170 s⁻¹, 25° C.).
E22. The well treatment fluid according to any one of Embodiments E1 to E21, further comprising a multimodal solids phase.
E23. The well treatment fluid according to any one of Embodiments E1 to E22, further comprising a solids phase having a packed volume fraction (PVF) greater than 0.7.
E24. The well treatment fluid according to any one of Embodiments E1 to E23, further comprising a viscoelastic surfactant in an amount ranging from 0.01 up to 7.2 g/L (60 ppt) based on the volume of fluid phase.
E25. The well treatment fluid according to any one of Embodiments E1 to E24, further comprising hydratable gelling agents in an amount ranging from 0.01 up to 4.8 g/L (40 ppt) based on the volume of fluid phase.
E26. The well treatment fluid according to any one of Embodiments E1 to E25, further comprising colloidal particles.
E27. The well treatment fluid according to any one of Embodiments E1 to E26, further comprising a solid particle-fluid density delta less than 1.6 g/mL.
E28. The well treatment fluid according to any one of Embodiments E1 to E27, further comprising particles having an aspect ratio of at least 6.
E29. The well treatment fluid according to any one of Embodiments E1 to E28, further comprising ciliated or coated proppant.
E30. A fracture treatment method, comprising: introducing into a fracture the well treatment fluid according to any one of embodiments E1 to E29.
E31. A fracture treatment method, comprising: forming a fracture in a subterranean formation penetrated by a wellbore; introducing into the fracture the well treatment fluid according to any one of embodiments E1 to E29, to form a proppant pack in the fracture; removing gas from the proppant pack to form hydraulically conductive channels; and producing a reservoir fluid through the proppant pack into the wellbore.
E32. A fracture treatment method, comprising: forming a fracture in a subterranean formation penetrated by a wellbore; introducing into the fracture a stabilized slurry comprising an Apollonian particle mixture comprising solids including at least one proppant mode dispersed in an energized carrier fluid with at least one additive selected from the group consisting of viscosifiers, gelling agents and rheological agents, to form a proppant pack in the fracture; removing gas from the proppant pack to form hydraulically conductive channels; and producing a reservoir fluid through the proppant pack into the wellbore.
E33. The fracture treatment method according to Embodiment E32 wherein the energized carrier fluid has a foam quality from 5 to 95%.
E34. The fracture treatment method according to Embodiment E32 or Embodiment E33 wherein the energized carrier fluid comprises foam.
E35. The fracture treatment method according to any one of Embodiments E32 to E34, wherein the particle mixture comprises a first proppant mode having a particle size greater than 100 microns and a second proppant mode having a particle size smaller than the first proppant mode.
E36. The fracture treatment method according to any one of Embodiments E32 to E35, wherein the carrier fluid further comprises a dispersed liquid phase immiscible in a continuous liquid phase.
E37. The fracture treatment method according to any one of Embodiments E32 to E36, wherein the stabilized slurry comprises a dispersed particle volume fraction (DPVF) of at least 40%, wherein the dispersed particles comprise solids, foam and optionally liquid particles.
E38. The fracture treatment method according to any one of Embodiments E32 to E37, wherein the carrier fluid is energized with carbon dioxide.
E39. The fracture treatment method according to any one of Embodiments E32 to E38, wherein the carrier fluid is energized with air, helium, argon, nitrogen, or hydrocarbon gases (such as methane, ethane, propane, butane, pentane, hexane, heptane . . . ), and mixtures thereof.
E40. The fracture treatment method according to any one of Embodiments E32 to E39, wherein the carrier fluid is energized with produced gas.
E41. The fracture treatment method according to any one of Embodiments E32 to E40, wherein the carrier fluid is energized with natural gas.
E42. The fracture treatment method according to any one of Embodiments E32 to E41, wherein the solids comprise at least two particle size modes comprising at least one proppant mode.
E43. The fracture treatment method according to any one of Embodiments E32 to E42, wherein the particle mixture comprises subproppant foam particles.
E44. The fracture treatment method according to any one of Embodiments E32 to E43, wherein the particle mixture comprises two proppant modes.
E45. The fracture treatment method according to any one of Embodiments E32 to E44, wherein the stabilized slurry comprises at least one of the stability indicia selected from: (1) a dispersed particle volume fraction (DPVF) of at least 0.4; (2) a low-shear viscosity of at least 1 Pa-s (5.11 s⁻¹, 25° C.); (3) a yield stress of at least 1 Pa; (4) an apparent viscosity of at least 50 mPa-s (170 s⁻¹, 25° C.); (5) a multimodal solids phase; (6) a solids phase having a packed volume fraction (PVF) greater than 0.7; (7) a viscosifier selected from viscoelastic surfactants, in an amount ranging from 0.01 up to 7.2 g/L (60 ppt), and hydratable gelling agents in an amount ranging from 0.01 up to 4.8 g/L (40 ppt) based, on the volume of fluid phase; (8) colloidal particles; (9) a solid particle-fluid density delta less than 1.6 g/mL; (10) particles having an aspect ratio of at least 6; (11) ciliated or coated proppant; and (12) combinations thereof.
E46. The fracture treatment method according to any one of Embodiments E32 to E45, wherein the stabilized slurry comprises a dispersed particle volume fraction (DPVF) of at least 0.4.
E47. The fracture treatment method according to any one of Embodiments E32 to E46, wherein the stabilized slurry comprises a dispersed particle volume fraction (DPVF) of at least 0.5.
E48. The fracture treatment method according to any one of Embodiments E32 to E47, wherein the stabilized slurry comprises a dispersed particle volume fraction (DPVF) of at least 0.6.
E49. The fracture treatment method according to any one of Embodiments E32 to E48, wherein the stabilized slurry comprises a low-shear viscosity of at least 1 Pa-s (5.11 s⁻¹, 25° C.).
E50. The fracture treatment method according to any one of Embodiments E32 to E49, wherein the stabilized slurry comprises a yield stress of at least 1 Pa.
E51. The fracture treatment method according to any one of Embodiments E32 to E50, wherein the stabilized slurry comprises an apparent viscosity of at least 50 mPa-s (170 s⁻¹, 25° C.).
E51. The fracture treatment method according to any one of Embodiments E32 to E50, wherein the stabilized slurry comprises a multimodal solids phase.
E52. The fracture treatment method according to any one of Embodiments E32 to E51, wherein the stabilized slurry comprises a solids phase having a packed volume fraction (PVF) greater than 0.7.
E53. The fracture treatment method according to any one of Embodiments E32 to E52, wherein the stabilized slurry comprises a viscoelastic surfactant in an amount ranging from 0.01 up to 7.2 g/L (60 ppt) based on the volume of fluid phase.
E54. The fracture treatment method according to any one of Embodiments E32 to E53, wherein the stabilized slurry comprises hydratable gelling agents in an amount ranging from 0.01 up to 4.8 g/L (40 ppt) based on the volume of fluid phase.
E55. The fracture treatment method according to any one of Embodiments E32 to E54, wherein the stabilized slurry comprises colloidal particles.
E56. The fracture treatment method according to any one of Embodiments E32 to E55, wherein the stabilized slurry comprises a solid particle-fluid density delta less than 1.6 g/mL.
E57. The fracture treatment method according to any one of Embodiments E32 to E56, wherein the stabilized slurry comprises particles having an aspect ratio of at least 6.
E58. The fracture treatment method according to any one of Embodiments E32 to E57, wherein the stabilized slurry comprises ciliated or coated proppant.
E59. The fracture treatment method according to any one of Embodiments E30 to E58, further comprising dispersing into the slurry a liquid phase immiscible in a continuous liquid phase.
E60. The fracture treatment method according to any one of Embodiments E30 to E59, wherein the energized carrier fluid comprises a foam quality effective to facilitate fluid loss control in the fracture.
E61. The fracture treatment method according to any one of Embodiments E30 to E60, wherein the energized carrier fluid comprises a foam quality effective to increase viscosity of the stabilized slurry and facilitate formation of a relatively wider fracture.
E62. The fracture treatment method according to any one of Embodiments E30 to E61, further comprising expanding gas in the carrier fluid to drive flowback through the proppant pack to the wellbore.
E63. The fracture treatment method according to any one of Embodiments E30 to E62, wherein the energized carrier fluid comprises a foam quality effective to promote slot flow of the solids in the fracture.
E64. The fracture treatment method according to any one of Embodiments E30 to E63, comprising energizing the carrier fluid with carbon dioxide.
E65. The fracture treatment method according to any one of Embodiments E30 to E64, comprising energizing the carrier fluid with air, helium, argon, nitrogen, or hydrocarbon gases (such as methane, ethane, propane, butane, pentane, hexane, heptane . . . ), and mixtures thereof.
E66. The fracture treatment method according to any one of Embodiments E30 to E65, comprising energizing the carrier fluid downhole with a foam-generating agent.
E67. The fracture treatment method according to any one of Embodiments E30 to E66, wherein the carrier fluid comprises surfactant to change wettability of a surface of the formation.
E68. The fracture treatment method according to any one of Embodiments E30 to E67, wherein the stabilized slurry is formed by at least one of: (1) introducing sufficient particles into the slurry to increase the dispersed particle volume fraction (DPVF) of the slurry to at least 0.4; (2) increasing a low-shear viscosity of the slurry to at least 1 Pa-s (5.11 s⁻¹, 25° C.); (3) increasing a yield stress of the slurry to at least 1 Pa; (4) increasing apparent viscosity of the slurry to at least 50 mPa-s (170 s⁻¹, 25° C.); (5) introducing a multimodal solids phase into the slurry; (6) introducing a solids phase having a packed volume fraction (PVF) greater than 0.7 into the slurry; (7) introducing into the slurry a viscosifier selected from viscoelastic surfactants and hydratable gelling agents; (8) introducing colloidal particles into the slurry; (9) reducing a particle-fluid density delta in the slurry to less than 1.6 g/mL; (10) introducing particles into the slurry having an aspect ratio of at least 6; (11) introducing ciliated or coated proppant into the slurry; and (12) combinations thereof.

### EXAMPLES

### Example 1

### Stabilized Treatment Slurry

An example of a stabilized treatment slurry (STS) is provided in Table 1 below.

TABLE 1
STS Composition.

| | Stabilized | Stabilized Proppant/ |
|---|---|---|
| | Proppant Free | Solids Slurry |
| Fluid components | Slurry (g/L of STS) | (g/L of STS) |
| Crystalline silica 40/70 mesh | 0 | 900-1100 |
| Crystalline silica 100 mesh | 0 | 125-225 |
| Crystalline silica 400 mesh | 600-800 | 100-250 |
| Calcium Carbonate¹ 2 micron | 300-400 | 175-275 |
| Water | 150-250 | 150-250 |
| Latex² | 300-500 | 100-300 |
| Dispersant³ | 2-4 | 2-4 |
| Antifoam⁴ | 3-5 | 1-3 |
| Viscosifier⁵ | 6-10 | 6-10 |

¹Calcium Carbonate = SAFECARB 2 from MI-SWACO
²Latex = Styrene-Butadiene copolymer dispersion
³Dispersant = Polynaphthalene sulfonate
⁴Antifoam = Silicone emulsion
⁵Viscosifier = AMPS/acrylamide copolymer solution

Excellent particle (proppant) suspension capability and very low fluid loss were observed. The fluid leakoff coefficient was determined by following the static fluid loss test and procedures set forth in Section 8-8.1, “Fluid loss under static conditions,” in Reservoir Stimulation, 3^{rd} Edition, Schlumberger, John Wiley & Sons, Ltd., pp. 8-23 to 8-24, 2000, in a filter-press cell using ceramic disks (FANN filter disks, part number 210538) saturated with 2% KC solution and covered with filter paper, and test conditions of ambient temperature (25° C.), a differential pressure of 3.45 MPa (500 psi), 100 ml sample loading, and a loss collection period of 60 minutes, or an equivalent test. The results are shown in FIG. 3. The total leakoff coefficient of STS was determined to be very low from the test. The STS fluid loss did not appear to be a function of differential pressure. This unique low to no fluid loss property, and excellent stability (low rate of solids settling), allows the STS to be pumped at a low rate without concern of screen out.

### Example 2

### Stabilized Treatment Slurry

Another example of an STS is provided in Table 2 below, which has an SVF of 60%. The fluid is very flowable and has been pumped into a subterranean formation with available field equipment. Typical slickwater operation has an SVF up to about 8% only. In contrast, the fluid in the current example delivers proppant at a much higher efficiency. It should be noted that not all of the solids in these embodiments are conventional proppant, and the 40/70 mesh proppant and 100 mesh sand are conventionally referred to as proppant. In this regard, the SVF of the conventional proppant in the total fluid is 44.2%, and the volumetric ratio of proppant to fluid phase is quite high, 44.2/39.9=1.11. This represents a breakthrough in water efficiency for proppant placement.

TABLE 2
STS Composition

| Components | Wt % | Vol % |
|---|---|---|
| 40/70 proppant | 49.7% | 37.5% |
| 100 mesh sand | 8.9% | 6.7% |
| 30μ silica | 8.9% | 6.7% |
| 2μ CaCO3 | 12.4% | 9.2% |
| Liquid Latex | 9.8% | 19.3% |
| Water and additives | 10.3% | 20.6% |

A low total water content in the STS results from both high proppant loading in the STS and the conversely relatively low amount of free water required for the slurry to be flowable/pumpable. Low water volume injection embodiments certainly result in correspondingly low fluid volumes to flow back. It can also be seen from the STS example in Table 2, the PVF of that formulation is 69%. This means that only 31% of the volume is fluid-filled voids. In a solid pack, a certain amount of water is retained due to capillary and/or surface wetting effects. The amount of retained water in this embodiment is higher than that of a conventional proppant pack, further reducing the amount of water flow back (in addition to inhibiting water infiltration into the matrix). Considering the statistical amount of water flowed back from a shale, carbonate or siltstone formation after a conventional fracturing treatment, in embodiments of the STS fracturing treatment the flow back is less than 30% or less than 20% or less than 10% of the water injected in the STS stage and/or the total water injected (including any pre-pad, pad, front-end, proppant, flush, and post-flush stage(s)), and there is a good chance that there may even be zero flow back.

As can be seen, to transport the same amount of proppant, the amount of water required is significantly reduced. To deliver 45,000 kg (100,000 lb) of proppant, a conventional slickwater treatment will require the use of 380 m³ (100,000 gallons) of water assuming the average slickwater proppant concentration is 0.12 kg/L (1 ppa). On the contrary, to deliver the same amount of proppant using the STS formulation of these embodiments, less than 11.3 m³ (3,000 gallons) of water are required, for a proppant stage placement v/v efficiency of 150 percent (volume of proppant placed is 1.5 times volume of water in proppant stage) versus 4.5 percent for the 1 ppa slickwater. The STS in this embodiment is using only 3% of the water that is required using the slickwater fracturing technique. Even considering any requirements of a pad, a flush and other non-STS fluid, the amount of water used by STS in this embodiment is still at least an order of magnitude less than the comparable slickwater technique, e.g., less than 10% of the water required for the slickwater technique. In embodiments, the proppant stage placement v/v water efficiency (volume of proppant/volume of water) is at least 10%, at least 20%, at least 30%, at least 40%, at least 50%, at least 60%, at least 70%, at least 80%, at least 90%, at least 100%, at least 110%, or at least 120%, and in additional or alternative embodiments the aqueous phase in the high-efficiency proppant stage has a viscosity less than 300 mPa-s.

### Example 3

### STS Slurry Stability Tests

A slurry sample was prepared with the formulation given in Table 3.

TABLE 3
STS Composition

| Components | g/L Slurry |
|---|---|
| 40/70 proppant | 700-800 |
| 100 mesh sand | 100-150 |
| 30μ silica | 100-140 |
| 2μ CaCO3 (SafeCARB2) | 150-200 |
| 0.036 wt % Diutan solution | 0.4-0.6 |
| Water and other additives | 250-350 |

The slurry was prepared by mixing the water, diutan and other additives, and SafeCARB particles in two 37.9-L (10 gallon) batches, one in an eductor and one in a RUSHTON turbine, the two batches were combined in a mortar mixer and mixed for one minute. Then the sand was added and mixed one minute, silica added and mixed with all components for one minute. A sample of the freshly prepared slurry was evaluated in a Fann 35 rheometer at 25° C. with an R1B5F1 configuration at the beginning of the test with speed ramped up to 300 rpm and back down to 0, an average of the two readings at 3, 6, 100, 200 and 300 rpm (2.55, 5.10, 85.0, 170 and 255 s⁻¹) recorded as the shear stress, and the yield stress (τ₀) determined as the y-intercept using the Herschel-Buckley rheological model.

The slurry was then placed and sealed with plastic in a 152 mm (6 in.) diameter vertical gravitational settling column filled with the slurry to a depth of 2.13 m (7 ft). The column was provided with 25.4-mm (1 in.) sampling ports located on the settling column at 190 mm (6′3″), 140 mm (4′7″), 84 mm (2′9″) and 33 mm (1′1″) connected to clamped tubing. The settling column was mounted with a shaker on a platform isolated with four airbag supports. The shaker was a BUTTKICKER brand low frequency audio transducer. The column was vibrated at 15 Hz with a 1 mm amplitude (vertical displacement) for two 4-hour periods the first and second settling days, and thereafter maintained in a static condition for 10 days (12 days total settling time, hereinafter “8 h@15 Hz/10 d static”). The 15 Hz/1 mm amplitude condition was selected to correspond to surface transportation and/or storage conditions prior to the well treatment.

At the end of the settling period the depth of any free water at the top of the column was measured, and samples were obtained, in order from the top sampling port down to the bottom. The post-settling period samples were similarly evaluated in the rheometer under the same configuration and conditions as the initial slurry, and the Herschel-Buckley yield stress calculated. The results are presented in Table 4.

TABLE 4
Rheological properties, initial and 8 h@15 Hz/10 d
Dynamic-static aged samples

| Shear Stress (Pa (lbf/100 ft2)) | | | | | Delta, |
|---|---|---|---|---|---|
| Shear Rate | 2.55 | 5.1 | 85 | 170 | @170 s⁻¹ |
| (s⁻¹): | | | | | (%) |
| Initial slurry | 17.9 | 21.3 | 84.5 | 135 | (base line) |
| | (37.4) | (44.5) | (176.4) | (282.7) | |

Aged slurry, 8 h@15 Hz/10 d static

| | | | | | |
|---|---|---|---|---|---|
| Top sample | 15.4 | 19.3 | 76.8 | 123 | −8.9 |
| | (32.1) | (40.4) | (160.3) | (257.1) | |
| Upper middle | 15.9 | 20.2 | 81.9 | 132 | −2.3 |
| sample | (33.3) | (42.2) | (171) | (276.1) | |
| Lower middle | 14.8 | 19.3 | 79.3 | 130 | −3.7 |
| sample | (30.9) | (40.4) | (165.7) | (271.4) | |
| Bottom sample | 18.6 | 22.7 | 89.6 | 146 | +8.1 |
| | (38.9) | (47.5) | (187.1) | (305.8) | |

Since the slurry showed no or low free water depth after aging, the apparent viscosities (taken as the shear rate) of the aged samples were all within 9% of the initial slurry, the slurry was considered stable. Since none of the samples had an apparent viscosity (calculated as shear rate/shear stress) greater than 300 mPa-s, the slurry was considered readily flowable. The carrier fluid was deionized water. Slurries were prepared by mixing the solids mixture and the carrier fluid. The slurry samples were screened for mixability and the depth of any free water formed before and after allowing the slurry to settle for 72 hours at static conditions. Samples which could not be mixed using the procedure described were considered as not mixable. The samples in which more than 5% free water formed were considered to be excessively settling slurries. The results were plotted in the diagram seen in FIG. 2.

From the data seen in FIG. 2, stable, mixable slurries were generally obtained where PVF is about 0.71 or more, the ratio of SVF/PVF is greater than 2.1*(PVF−0.71), and, where PVF is greater than about 0.81, SVF/PVF is less than 1-2.1*(PVF−0.81). These STS systems were obtained with a low carrier fluid viscosity without any yield stress. By increasing the viscosity of the carrier fluid and/or using a yield stress fluid, an STS may be obtained in some embodiments with a lower PVF and/or a with an SVF/PVF ratio less than 1-2.1*(PVF−0.71).

### Example 5

### Slot Orifice Flow Data

The multimodal STS system has an additional benefit in these embodiments in that the smaller particles in the voids of the larger particles act as slip additives like mini-ball bearings, allowing the particles to roll past each other without any requirement for relatively large spaces between particles. This property was demonstrated by the flow of the Table 2 STS formulation of these embodiments through a small slot orifice. In this experiment, the slurry was loaded into a cell with bottom slot opened to allow fluid and solid to come out, and the fluid was pushed by a piston using water as a hydraulic fluid supplied with an ISCO pump at a rate of 20 mL/min. The slot at the bottom of the cell was adjusted to different openings, 1.8 mm (0.0708 in.) and 1.5 mm (0.0591 in.). A few results of different slurries flowing through the slots are shown in Table 5.

TABLE 5
Results of different slurries flowing through different opening slots

| | % slurry | % slurry |
|---|---|---|
| | flowed through 1.8 mm | flowed through 1.5 mm |
| Fluid | (0.0708 in.) slot | (0.0591 in.) slot |
| Slickwater with high | 20%* | 0% |
| ppa | | |
| 60% SVF STS | 100% | 50% |
| 50% SVF STS | 100% | 100% |

*The slurry flowed out of the cell has less solid than what was left inside the cell, biggest particle in the formulation was 400 microns (0.0165 in.).

It can be seen from the results that the passage of the STS through the slot in this embodiment was facilitated, which validates the flowability observation. With the larger slot the ratio of slot width to largest proppant diameter was about 4.5; but just 3.75 in the case of the smaller slot. The slickwater technique requires a ratio of perforation diameter to proppant diameter of at least 6, and additional enlargement for added safety to avoid screen out usually dictates a ratio of at least 8 or 10 and does not allow high proppant loadings. In embodiments, the flowability of the STS through narrow flow passages (ratio of diameter of proppant to diameter or width of flow passage less than 6, e.g., less than 5, less than 4 or less than 3 or a range of 2 to 6 or 3 to 5) such as perforations and fractures is similarly facilitated, allowing a smaller ratio of perforation size to proppant size as well as a narrower fracture that still provides transport of the proppant to the tip, i.e., improved flowability of the proppant in the fracture and improved penetration of the proppant-filled fracture extending away from the wellbore into the formation. These embodiments provide a relatively longer proppant-filled fracture prior to screenout relative to slickwater or high-viscosity fluid treatments.

### Examples 6-9

### Additional Formulations

Additional STS formulations were prepared as shown in Table 2. Example 6 was prepared without proppant and exemplifies a high-solids stabilized slurry without proppant that can be used as a treatment fluid, e.g., as a spacer fluid, pad or managed interface fluid to precede or follow a proppant-containing treatment fluid. Example 7 was similar to Example 6 except that it contained proppant including 40/70 mesh and 100 mesh sand. Example 8 was prepared with gelling agent instead of latex. Example 9 was similar to Example 8, but was prepared with dispersed oil particles instead of calcium carbonate. Examples 7-9 exemplify treatment fluids suitable for fracturing low permeability formations.

TABLE 6
STS Composition and Properties

| STS | | Example 6 | Example 7 | Example 8 | Example 9 |
|---|---|---|---|---|---|
| Components | Size (μm) | Wt % | Wt % | Wt % | Wt % |
| 40/70 proppant | 210-400 | — | 50-55 | 50-55 | 50-55 |
| 100 mesh sand | 150 | — | 8-12 | 8-12 | 8-12 |
| CaCO3 | 2.5-3 | 20-25 | 8-12 | 8-12 | — |
| Liquid Latex | 0.18 | 20-25 | 8-12 | — | — |
| Viscosifier | — | 0.1-1 | 0.1-1 | — | — |
| Anti-foam | — | 0.05-0.5 | 0.05-0.5 | — | — |
| Gelling agent | — | — | — | 0.01-0.05 | 0.01-0.05 |
| Dispersant | — | 0.05-0.5 | 0.05-0.5 | 0.05-0.5 | — |
| Breaker | — | — | — | 0.01-0.1 | 0.01-0.1 |
| Breaker aid | — | — | — | 0.005-0.05 | 0.005-0.05 |
| Oil | — | — | — | — | 2-3 |
| Surfactant | — | — | — | — | 0.1-1 |
| Water | — | 8-12 | 8-12 | 18-22 | 18-22 |

Rheology

| | | | | |
|---|---|---|---|---|
| Yield Point (Pa) | 11.5 | 8.9 | 15.3 | 13.5 |
| K (Pa-sⁿ) | 5.41 | 3.09 | 1.42 | 2.39 |
| n | 0.876 | 0.738 | 0.856 | 0.725 |
| Stability (static 72 h) | Stable | Stable | Stable | Stable |

Leakoff control

| | | | | |
|---|---|---|---|---|
| Cw (ft/min^{1/2}) | 0.0002 | 0.00015 | 0.003 | 0.0014 |
| Filter cake (mm) | ~1 | <1 | ~5 | ~5 |
| Clean up permeability (D) | ND | ND | 0.004-0.024 | 1-1.2 |

Fluid Properties

| | | | | |
|---|---|---|---|---|
| SVF (%) | 40 (60*) | 60 (70*) | 60 | 54 (60*) |
| Specific gravity | 1.68 | 2 | 2 | 1.88 |
| PPA (whole fluid) | NA | 14 | 14 | 13.6 |

Notes:
ND = not determined;
NA = not applicable;
*= including latex or oil

All of the fluids were stable, and had a yield point above 10 Pa and a viscosity less than 10 Pa-s. Rheological, leak-off control and other fluid properties are given in Table 6.

### Example 10

### Energized STS

A high solid content slurry was prepared using three sands: 40/70 mesh sand (75.5% by volume of solids, “BVOB”), 100 mesh sand (12.8% BVOB) and 400 mesh sand (10% BVOB). The carrier fluid was water with 30 mUL (30 gallons per thousand gallons (gpt)) surfactant gelling agent and 5 mL/L (5 gpt) rheology modifier. The slurry components are given in Table 7.

TABLE 7
Energized STS Composition

| Components | Wt (g) | Conc. |
|---|---|---|
| 40/70 mesh sand | 514 | 75.5% BVOB |
| 100 mesh sand | 87 | 12.8% BVOB |
| 400 mesh sand | 80 | 11.7% BVOB |
| Water | 234.9 | 100% BVOL |
| Surfactant | 7.05 | 30 mL/L |
| Rheology modifier | 1.14 | 5 mL/L |

The slurry was prepared by first mixing the surfactant gelling agent and rheology modifier in water using a WARING blender and subsequently the prepared gel was centrifuged at 3000 rpm for 15 minutes to remove any entrapped air prior to adding the three sands of different particle size giving 51% SVF. The foamed slurry was then prepared by shearing it in the blender until it gave 35% foam quality. The foam quality was calculated by the change in volume after shearing divided by the final volume.

### Example 11

### Fluid Loss Characteristics of Energized STS

In this example the impact of foamed and non-foamed slurry on fluid loss was compared since a slurry with a better fluid loss control aids in reliable and efficient proppant placement. The slurries were prepared using the procedure described in Example 10 using the formulation given in Table 8 for 500 mL volume of slurry.

TABLE 8
Energized/Non-Energized STS Composition

| Components | Wt (g) | Conc. |
|---|---|---|
| 40/70 mesh sand | 514 | 75.5% BVOB |
| 100 mesh sand | 87 | 12.8% BVOB |
| 400 mesh sand | 80 | 11.7% BVOB |
| Water | 238.7 | 100% BVOL |
| Surfactant | 3.58 | 15 mL/L |
| Rheology modifier | 0.76 | 3.3 mL/L |

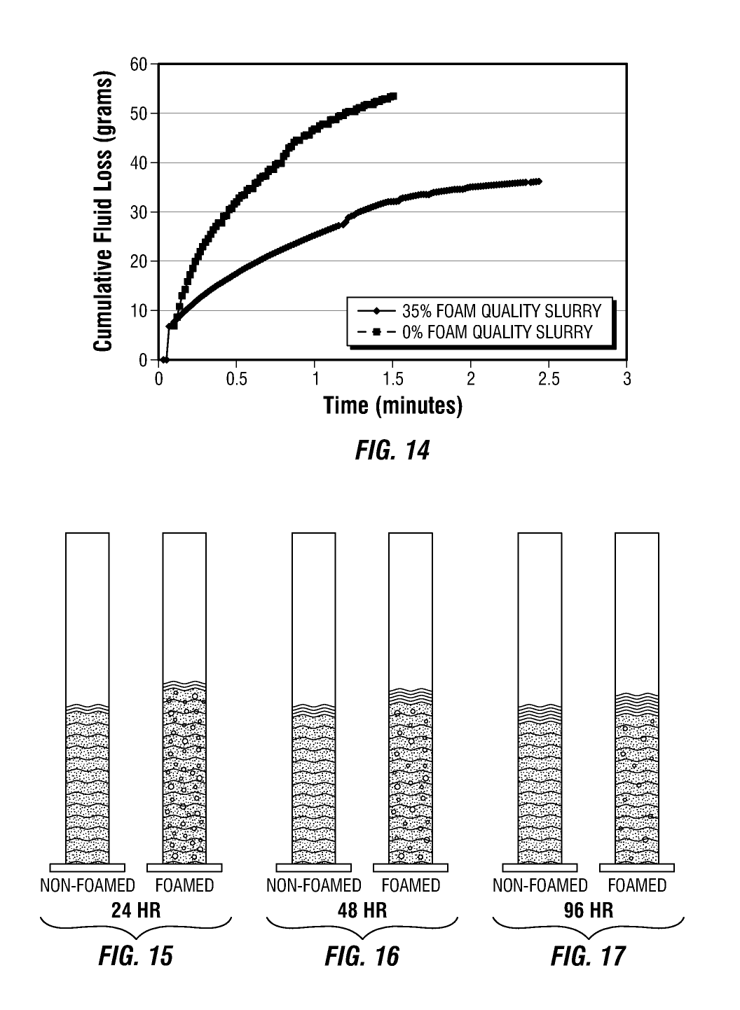

The non-foamed slurry was prepared by mixing the surfactant gelling agent and rheology modifier in water using a WARING blender and subsequently the prepared gel was centrifuged at 3000 rpm for 15 minutes to remove any entrapped air prior to adding the three sands of different particle size giving 51% SVF. A foamed slurry was prepared in the same manner and then subsequently sheared in the blender until it gave 35% foam quality. Fluid loss tests were subsequently performed using 100 mL of slurry at 3.45 MPa (500 psi) pressure on a 2.7 micron filter paper resting on top of a 10 mD ceramic filter disc. FIG. 14 shows that the foamed slurry reduced the fluid loss compared to the non-foamed slurry, hence facilitating reliable slurry placement.

### Example 12

### Rheology Characteristics of Energized STS

The viscosity of the foamed and non-foamed slurries described in Example 11 was measured at ambient using a CHANDLER 35 viscometer fitted with an R1B5 rotor-bob combination and spring 1 at 60 rpm (51 s⁻¹). The foamed slurry gave a higher apparent viscosity (498 mPa-s) compared to the non-foamed slurry (291 MPa-s). The viscosity comparison was confirmed by observing the time taken for the two slurries with the same volume to flow through a funnel with an outlet diameter of 18 mm; the foamed slurry had a flow time of 10.1 seconds, compared to just 6.9 for the non-foamed slurry. To the extent a fluid with a higher viscosity will give a wider fracture width compared with a lower viscosity fluid, the data show the foamed STS may generally provide a wider fracture width.

### Example 13

### Stability Characteristics of Energized STS

The stability of the non-foamed and foamed slurries from Example 11 was studied. The prepared non-foamed slurry (140 mL) and a foamed slurry 189 mL (140 mL foamed with 35% foam quality) were placed in measuring cylinders and left standing at ambient for 4 days and their sedimentation was monitored after 24, 48 and 96 hours as shown in FIGS. 15-17. After 24 hours (FIG. 15), the foamed slurry (right) suggested an equivalent or slower phase separation compared with the non-foamed fluid (left). After 96 hours (FIG. 17), the sedimentation of the foamed slurry (right) was marginally better than the non-foamed slurry (left) and the volume of the liquid phase above the sedimentation was similar. This example demonstrates that foam aids in the suspension of solids for a longer time compared with a non-foamed slurry, thus extending the storage time at the surface.

While the disclosure has provided specific and detailed descriptions to various embodiments, the same is to be considered as illustrative and not restrictive in character. Only certain example embodiments have been shown and described. Those skilled in the art will appreciate that many modifications are possible in the example embodiments without materially departing from the disclosure. Accordingly, all such modifications are intended to be included within the scope of this disclosure as defined in the following claims.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. In the claims, means-plus-function clauses are intended to cover the structures described herein as performing the recited function and not only structural equivalents, but also equivalent structures. For example, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

We claim:

1. A well treatment fluid, comprising:
a stabilized, flowable slurry comprising an Apollonian particle mixture comprising solids dispersed in an energized carrier fluid with at least one additive selected from the group consisting of viscosifiers, gelling agents and rheological agents.

2. The fluid of claim 1, wherein the solids mixture comprises a first proppant mode having a particle size greater than 100 microns and a second proppant mode having a particle size smaller than the first proppant mode.

3. The fluid of claim 1, wherein the carrier fluid further comprises a dispersed liquid phase immiscible in a continuous liquid phase.

4. The fluid of claim 1, comprising a dispersed particle volume fraction (DPVF) of at least 40%, wherein the dispersed particles comprise solids, foam and optionally liquid particles.

5. The fluid of claim 1, wherein the carrier fluid is energized with carbon dioxide.

6. The fluid of claim 1, wherein the carrier fluid is energized with air, helium, argon, nitrogen, or hydrocarbon gases (such as methane, ethane, propane, butane, pentane, hexane, heptane . . . ), and mixtures thereof.

7. The fluid of claim 1, wherein the solids comprise proppant.

8. The fluid of claim 1, wherein the solids comprise at least two particle size modes comprising at least one proppant mode.

9. The fluid of claim 8, wherein the particle mixture comprises subproppant foam particles.

10. The fluid of claim 1, comprising two proppant modes.

11. The fluid of claim 1, further comprising at least one of the stability indicia selected from: (1) a dispersed particle volume fraction (DPVF) of at least 0.4; (2) a low-shear viscosity of at least 1 Pa-s (5.11 s⁻¹, 25° C.); (3) a yield stress of at least 1 Pa; (4) an apparent viscosity of at least 50 mPa-s (170 s⁻¹, 25° C.); (5) a multimodal solids phase; (6) a solids phase having a packed volume fraction (PVF) greater than 0.7; (7) a viscosifier selected from viscoelastic surfactants, in an amount ranging from 0.01 up to 7.2 g/L (60 ppt), and hydratable gelling agents in an amount ranging from 0.01 up to 4.8 g/L (40 ppt) based, on the volume of fluid phase; (8) colloidal particles; (9) a solid particle-fluid density delta less than 1.6 g/mL; (10) particles having an aspect ratio of at least 6; (11) ciliated or coated proppant; and (12) combinations thereof.

12. A fracture treatment method, comprising:
forming a fracture in a subterranean formation penetrated by a wellbore;
introducing into the fracture a stabilized slurry comprising an Apollonian particle mixture comprising solids including at least one proppant mode dispersed in an energized carrier fluid with at least one additive selected from the group consisting of viscosifiers, gelling agents and rheological agents, to form a proppant pack in the fracture;
removing gas from the proppant pack to form hydraulically conductive channels; and
producing a reservoir fluid through the proppant pack into the wellbore.

13. The method of claim 12, wherein the proppant pack comprises a first proppant mode having a particle size greater than 100 microns and a second proppant mode having a particle size smaller than the first proppant mode.

14. The method of claim 12, further comprising dispersing into the slurry a liquid phase immiscible in a continuous liquid phase.

15. The method of claim 12, wherein the energized carrier fluid comprises a foam quality effective to facilitate fluid loss control in the fracture.

16. The method of claim 12, wherein the energized carrier fluid comprises a foam quality effective to increase viscosity of the stabilized slurry and facilitate formation of a relatively wider fracture.

17. The method of claim 12, further comprising expanding gas in the carrier fluid to drive flowback through the proppant pack to the wellbore.

18. The method of claim 12, wherein the energized carrier fluid comprises a foam quality effective to promote slot flow of the solids in the fracture.

19. The method of claim 12, wherein the stabilized slurry comprises a dispersed particle volume fraction (DPVF) of at least 40%, wherein the dispersed particles comprise solids, foam and optionally liquid particles.

20. The method of claim 12, comprising energizing the carrier fluid with carbon dioxide.

21. The method of claim 12, comprising energizing the carrier fluid with air, helium, argon, nitrogen, or hydrocarbon gases (such as methane, ethane, propane, butane, pentane, hexane, heptane . . . ), and mixtures thereof.

22. The method of claim 12, comprising energizing the carrier fluid downhole with a foam-generating agent.

23. The method of claim 12, wherein the carrier fluid comprises surfactant to change wettability of a surface of the formation.

24. The method of claim 12, wherein the stabilized slurry is formed by at least one of: (1) introducing sufficient particles into the slurry to increase the dispersed particle volume fraction (DPVF) of the slurry to at least 0.4; (2) increasing a low-shear viscosity of the slurry to at least 1 Pa-s (5.11 s⁻¹, 25° C.); (3) increasing a yield stress of the slurry to at least 1 Pa; (4) increasing apparent viscosity of the slurry to at least 50 mPa-s (170 s⁻¹, 25° C.); (5) introducing a multimodal solids phase into the slurry; (6) introducing a solids phase having a packed volume fraction (PVF) greater than 0.7 into the slurry; (7) introducing into the slurry a viscosifier selected from viscoelastic surfactants and hydratable gelling agents; (8) introducing colloidal particles into the slurry; (9) reducing a particle-fluid density delta in the slurry to less than 1.6 g/mL; (10) introducing particles into the slurry having an aspect ratio of at least 6; (11) introducing ciliated or coated proppant into the slurry; and (12) combinations thereof.
